(19) United States
(12) Patent Application Publication
(10) Pub. No.: US 2011/0052019 A1
(43) Pub. Date: Mar. 3, 2011

(54) Analyzing Objects Via Hyper-Spectral Imaging and Analysis

(75) Inventor: Danny MOSHE, Kiryat Ono (IL)

(73) Assignee: GREEN VISION SYSTEMS LTD., Tel Aviv (IL)

(21) Appl. No.: 12/870,088

(22) Filed: Aug. 27, 2010

Related U.S. Application Data
(60) Provisional application No. 61/239,480, filed on Sep. 3, 2009.

(51) Int. Cl. G06K 9/00

(52) U.S. Cl. 382/128

(57) ABSTRACT

Analyzing and classifying an object via hyper-spectral imaging and analysis. Generating, collecting respective reference objects and object hyper-spectral image data and information, of: (i) a set of reference objects related to or/and associated with the object, and (ii) the object, via a hyper-spectral imaging and analysis system. Forming, storing: (i) global reference database associated with reference objects hyper-spectral image data and information, and (ii) object database associated with object hyper-spectral image data and information, respectively, by processing and analyzing reference objects and object hyper-spectral image data and information, via a data-information processing and analyzing unit. Forming, storing a sub-global reference database associated with a sub-set of reference objects hyper-spectral image data and information and with a sub-set of the global reference database, by processing and analyzing reference objects and object hyper-spectral image data and information, and, the global reference database and the object database. Identifying, storing an object classification, by processing and analyzing the object database and the sub-global reference database, via the data-information processing and analyzing unit.

### FIELD OF THE INVENTION

The present invention relates to hyper-spectral imaging and analysis, in general, generating and collecting hyper-spectral images, and, processing and analyzing hyper-spectral image data and information, in particular. More particularly, the present invention relates to a method of analyzing and classifying objects via hyper-spectral imaging and analysis.

The present invention is generally applicable for on-line (e.g., real time or near-real time) or off-line analyzing and classifying essentially any type or kind of biological, physical, or/and chemical, (i.e., biophysicochemical) object (entity, material, substance, or structure), wherein the object is composed or made up of essentially any type, kind, and number of species or components, which in turn, are made up of essentially any type, kind, and number of organic or/and inorganic materials or substances. Some embodiments of the present invention are particularly applicable for analyzing and classifying objects that are included in agricultural products (e.g., plant matter, in raw or processed (finished) form), in environmental matter (e.g., contaminated air (aerosol), water, or ground), in food products (and raw materials thereof), in pharmaceutical products (and raw materials thereof), or in aerial observations or views of air, land (ground), or water (such as of polluted air, water, or land (ground)). The present invention is generally applicable to essentially any field or area of technology which involves analyzing and classifying objects. The present invention is generally applicable to remote sensing of objects which involves analyzing and classifying the objects. The present invention provides the capability of achieving the ‘ultimate’ combination of the highly desirable object analysis and classification performance parameters of high accuracy, ‘and’ high precision (high reproducibility), ‘and’ high resolution, ‘and’ high sensitivity, ‘and’ at high speed (short time scale), all at the same time (i.e., simultaneously), be it during on-line or off-line, in an optimum and highly efficient manner.

### BACKGROUND OF THE INVENTION

### Hyper-Spectral Imaging and Analysis

Hyper-spectral imaging and analysis has been established as a highly unique, specialized, and sophisticated, combined spectroscopy and imaging type of analytical method or technique, in the more encompassing field or area of analytical science and technology, involving the sciences and technologies of spectroscopy and imaging. By definition, hyper-spectral imaging and analysis is based on a combination of spectroscopy and imaging theories, principles, and practices, which are exploitable for analyzing and classifying samples of biological, physical, or/and chemical, (i.e., biophysicochemical), matter in a highly unique, specialized, and sophisticated, manner.

Hyper-spectral imaging, in general, generating and collecting hyper-spectral images, and, processing and analyzing hyper-spectral image data and information, in particular, theory, principles, and practices thereof, and, related and associated applications and subjects thereof, such as the more general subject of spectral imaging, are well known and taught about in scientific, technical, and patent, literature, and currently practiced in a wide variety of numerous different fields and areas of science and technology. Several examples of such teachings and practices are disclosed in references 1-19 (and references cited therein). Selected teachings and practices of hyper-spectral imaging and analysis by the same applicant/assignee of the present invention are disclosed in references 20-27 (and references cited therein). For assisting in establishing the field, scope, and meaning, of the present invention, and in understanding problems solved by the present invention, the following background is provided.

In sharp contrast to the regular or standard spectroscopic imaging technique of ‘spectral’ imaging and analysis, the more highly specialized, complex, and sophisticated, spectroscopic imaging technique of ‘hyper-spectral’ imaging and analysis, consists of using a hyper-spectral imaging and analysis system for on-line (real time, near-real time) or off-line generating and collecting (acquiring) hyper-spectral images and spectra (herein, together, generally referred to as hyper-spectral image data and information), and, processing and analyzing the acquired hyper-spectral image data and information. In hyper-spectral imaging, multiple fields of view of an object (and components thereof) (for example, included in a sample of matter) is ‘hyper-spectrally’ scanned and imaged while the object (and components thereof) is exposed to electromagnetic radiation.

During the hyper-spectral scanning and imaging there is generating and collecting relatively large numbers (up to the order of millions) of multiple spectral (i.e., hyper-spectral) images, ‘one-at-a-time’, but, in an extremely fast or rapid sequential manner, of the objects (and components thereof) emitting electromagnetic radiation at a plurality of many wavelengths (or frequencies, or energies), where the wavelengths (or frequencies, or energies) are associated with different selected (relatively narrow) portions or bands, or bands therein, of an entire hyper-spectrum emitted by the objects (and components thereof). A hyper-spectral imaging and analysis system can be operated in an extremely fast or rapid manner for providing exceptionally highly resolved spectral and spatial data and information of an imaged object (and components thereof), with high accuracy and high precision (reproducibility), which are fundamentally unattainable by using a regular or standard spectral imaging and analysis system.

In general, when electromagnetic radiation, for example, in the form of light such as that supplied by the sun, or by a man-made imaging type of illuminating or energy source, such as that used during hyper-spectral imaging, is incident upon an object, the electromagnetic radiation is affected by one or more of the biological, physical, or/and chemical, (biophysicochemical) species or components making up the object, by any combination of electromagnetic radiation absorption, diffusion, reflection, diffraction, scattering, or/and transmission, mechanisms. Moreover, an object whose composition includes organic chemical species or components, ordinarily exhibits some degree or extent of fluorescent or/and phosphorescent properties, characteristics, and behavior, when illuminated by some type of electromagnetic radiation or light, such as ultra-violet (UV), visible (VIS), or infrared (IR), types of light. The affected electromagnetic radiation, in the form of diffused, reflected, diffracted, scattered, or/and transmitted, electromagnetic radiation emitted by, or/and emerging from, the object (and components thereof), is directly and uniquely related to, and can be correlated with, the biological, physical, chemical, (biophysicochemical) properties, characteristics, and behavior, of the object, in general, and of the biological, physical, or/and chemical, (biophysicochemical) species or components making up the object, in particular, and therefore represents a spectral (‘fingerprint’ or ‘signature’) pattern type of identification and characterization of the object, which is directly applicable for analyzing and classifying the object.

Accordingly, hyper-spectral images generated by, and collected from, an object (and components thereof) are correlated with emission spectra of the object (and components thereof), where the emission spectra correspond to spectral representations in the form of spectral ‘fingerprint’ or ‘signature’ pattern types of identification and characterization, of the hyper-spectrally imaged object (and components thereof). Such hyper-spectral image data and information are processed and analyzed by using automatic pattern recognition (APR) or/and optical character recognition (OCR) types of hyper-spectral imaging data and information processing and analysis, for identifying, characterizing, or/and classifying, the biological, physical, or/and chemical, (biophysicochemical) properties, characteristics, and behavior, and, species or components, of the hyper-spectrally imaged object (and components thereof).

### OBJECT

Herein, in the context of the field and art of the present invention, the term ‘object’ generally refers to, and is considered synonymous with, at least part of an entity, material, substance, or structure, which, singly or in combination with other objects (entities, materials, substances, or structures), typically as part of a scene (defined hereinbelow), is subjectable to a hyper-spectral imaging process or technique. In general, such an object is composed or made up of essentially any type, kind, and number of species or components, which in turn, are made up of essentially any type, kind, and number of organic or/and inorganic materials or substances. In general, such an object (and species or components thereof) is definable and characterizable by a set of a wide variety of numerous possible biological, physical, or/and chemical, (biophysicochemical) properties, characteristics, and behavior, and, species or components.

### Hyper-Spectral Imaging—Generating and Collecting the Hyper-Spectral Image Data and Information

Herein, in the context of the field and art of the present invention, in hyper-spectral imaging, an object (as defined hereinabove) or objects, typically as part of a scene, is/are exposed to natural or/and man-made electromagnetic radiation, followed by generation and collection of multiple spectral (i.e., hyper-spectral) images, via a single field of view, or via a plurality of fields of view, of the object(s) emitting electromagnetic radiation having wavelengths (or frequencies, energies) associated with different selected (relatively narrow) portions or bands, or bands therein, of an entire spectrum emitted by the object(s). Hyper-spectral images generated by, and collected from, the object(s) (and components thereof), are correlated with emission spectra of the object(s) (and components thereof), where the emission spectra correspond to spectral representations in the form of spectral ‘fingerprint’ or ‘signature’ pattern types of identification and characterization, of the hyper-spectrally imaged object(s) (and components thereof).

### Imaged Scene of Objects in Hyper-Spectral Imaging

Typically, one performs hyper-spectral imaging of an object or of objects (and components thereof), as part of a scene, in order to ultimately observe and measure micro scale or/and macro scale (qualitative or/and quantitative) biological, physical, or/and chemical, (biophysicochemical) properties, characteristics, and behavior, of the imaged object(s) (and components thereof) which are readily interpretable, understandable, and further usable, by a human observer, viewer, analyzer, or/and controller (herein, generally referred to as an operator) of a process involving the imaged object(s) in the scene. Herein, a scene generally refers to surroundings or a place of (i.e., including or containing) a single object, or, a plurality, collection, or ensemble, of several objects (i.e., entities, materials, substances, or structures), wherein takes place or occurs a (static or dynamic) action or event involving the object(s). Accordingly, in the context of the field and art of the present invention, in hyper-spectral imaging, an imaged scene generally corresponds to one or more hyper-spectral images, associated with one or more fields of view, of surroundings or a place of (i.e., including or containing) a single object, or, a plurality, collection, or ensemble, of several objects (i.e., entities, materials, substances, or structures), wherein takes place or occurs a (static or dynamic) action or event involving the imaged object(s). Moreover, in hyper-spectral imaging, an imaged scene includes or contains hyper-spectral image data and information relating to the imaged object(s) (and components thereof), particularly in the form of spectral representations, such as spectral fingerprint or signature pattern types of identification and characterization, of the imaged object(s) (and components thereof).

### Types, Categories, or Classes (Classifications), of Objects in Hyper-Spectral Imaged Scenes

In general, a scene (as defined hereinabove) can be considered as including or containing any number of objects which can be typed, categorized, or classified, according to any number of different types, categories, or classes (classifications), of objects. Accordingly, in hyper-spectral imaging, individual objects among a plurality, collection, or ensemble, of several objects (i.e., entities, materials, substances, or structures) of (included or contained in) the surroundings or place of a scene which is imaged in one or more hyper-spectral images, via one or more fields of view, can be typed, categorized, or classified, according to different types, categories, or classes, of objects.

Each different general type, category, or class (classification), of objects of (included or contained in) a scene is definable or characterizable by one or more sets of a priori or pre-determined known data, information, and parameters, (e.g., in the form of databases of theoretically or/and empirically determined data, information, and parameters) and rules for using thereof, which are obtained and established by an operator of a process involving the objects of (included or contained in) the scene. For example, such sets of a priori or pre-determined known data, information, and parameters, are typically based on databases of theoretically or/and empirically determined ‘hyper-spectral’ data, information, and parameters, and, on databases of theoretically or/and empirically determined biological, physical, or/and chemical, (biophysicochemical) data, information, and parameters, which are associatable and correlatable with the objects of the scene, and which are applicable for uniquely identifying (recognizing), discriminating, comparing, filtering, sorting, quantifying, characterizing, and classifying, the objects of the scene.

### Processing and Analyzing Hyper-Spectral Image Data and Information

Typically, specific (relatively narrow) portions or bands, or bands therein, of wavelengths (or frequencies, or energies) and wavelength (or frequency, or energy) ranges of the electromagnetic radiation emitted by the object(s) are empirically determined, and then exploited during hyper-spectral imaging, for generating and collecting hyper-spectral images which contain a plethora of hyper-spectral image data and information relating to the imaged object(s) (and components thereof), including in the form of spectral representations, such as spectral fingerprint or signature pattern types of identification and characterization, of the imaged object(s) (and components thereof), that need to be processed and analyzed.

In general, one may consider ‘processing’, and ‘analyzing’, of hyper-spectral image data and information as two separate, but integrated, main activities, as follows. One may consider ‘processing’ of hyper-spectral image data and information as being based on, and involving, real time (i.e., in-line or on-line) or/and non-real time (i.e., off-line) automatic (i.e., computerized) data and information manipulating, handling, or/and moving, types of procedures or/and operations. One may consider ‘analyzing’ of hyper-spectral image data and information as being based on, and involving, real time (i.e., in-line or on-line) or/and non-real time (i.e., off-line) automatic (i.e., computerized) data and information analyzing, identifying (recognizing), discriminating, comparing, filtering, sorting, quantifying, characterizing, and classifying, types of procedures or/and operations. Together, in an integrated manner, real time or/and non-real time ‘processing’ and ‘analyzing’ of the hyper-spectral image data and information are performed for the main goal of relating and translating the hyper-spectral image data and information of the imaged object(s) (and components thereof) to micro scale or/and macro scale (qualitative or/and quantitative) biological, physical, or/and chemical, (biophysicochemical) properties, characteristics, and behavior, of the imaged object(s) (and components thereof) which are readily interpretable, understandable, and further usable, by an operator of a process involving the imaged object(s).

### Accuracy, Precision (Reproducibility), Sensitivity, and Speed (Time Scale), of Hyper-Spectral Imaging

A scene which is imaged in one or more hyper-spectral images, via one or more fields of view, includes or contains a plurality, collection, or ensemble, of several objects (i.e., entities, materials, substances, or structures), wherein, there exists a number of objects which are objects of interest (targets), and objects of non-interest (background). The plethora of hyper-spectral image data and information represented by, and contained in, hyper-spectral images, via one or more fields of view, of a scene of (including or containing) objects must be processed and analyzed, in particular, by using various combinations of known sets or databases of (theoretically or/and empirically determined) ‘hyper-spectral image’ and ‘biophysicochemical’ data, information, and parameters, and rules for using thereof, for uniquely identifying (recognizing), discriminating, quantifying, characterizing, and classifying, each object of the imaged scene as being an object of interest (a target), or as being an object of non-interest (background). Only as a result of the integrated processing and analyzing of the hyper-spectral image data and information of the imaged scene of objects, can the hyper-spectral image data and information of the objects be related and translated to micro scale or/and macro scale (qualitative or/and quantitative) biophysicochemical properties, characteristics, and behavior, of the imaged object(s) (and components thereof) which are readily interpretable, understandable, and further usable, by an operator of a process involving the imaged object(s).

Many, if not all, hyper-spectral imaging and analysis applications involve automatically generating and collecting a relatively large number (e.g., on the order of hundreds, thousands, or millions) of individual hyper-spectral images (each containing a plurality of emission spectra, spectral fingerprints, and spectral patterns), typically, via a plurality of different fields of view, of a plurality of scenes, wherein each scene includes or contains a single object, or a plurality, collection, or ensemble, of several objects (entities, materials, substances, or structures). Accordingly, such hyper-spectral imaging and analysis applications necessarily involve processing and analyzing ‘huge’ amounts of ‘raw’ hyper-spectral image data and information.

Performance of a given hyper-spectral imaging and analysis application is based on, and influenced by, accuracy, precision (i.e., reproducibility), and sensitivity, of several parameters, and particularly of the main parameter of (spectral and spatial) resolution. Spectral resolution relates to the resolution of the optically detected electromagnetic radiation of the affected energy or emission beam emitted by, and emerging from, illuminated objects of (included or contained in) a scene, from which are generated optical forms, and electronic forms, of hyper-spectral images of the illuminated objects. Spatial resolution relates to the resolution of the topological, morphological or geometrical spaces or/and dimensions within or/and between the various biophysicochemical species, components, or elements which comprise a given object (entity, material, substance, or structure) of (included or contained in) an imaged scene. Speed (time scale) relates to the speed (time scale) at which part of a process, or an entire process, of the hyper-spectral imaging and analysis application is performed.

Ordinarily, an operator of a given hyper-spectral imaging and analysis application inherently desires highly accurate, highly precise (i.e., reproducible), and highly sensitive, generation and collection of hyper-spectral images, as well as highly accurate, highly precise, and highly sensitive, processing and analyzing of the generated and collected ‘raw’ hyper-spectral image data and information. In addition to, and related to, high accuracy, high precision, and high sensitivity, of generating and collecting hyper-spectral images, and, of processing and analyzing the ‘raw’ hyper-spectral image data and information therefrom, there is the speed (or time scale) at which these activities and procedures are performed. Ideally, an operator of a given hyper-spectral imaging and analysis application inherently desires that generating and collecting hyper-spectral images, and, processing and analyzing the ‘raw’ hyper-spectral image data and information therefrom, be performed as highly accurately, as highly precise (reproducible), and as highly sensitive, as technically possible or feasible, at as high a speed (or short time scale) as technically possible or feasible, in accordance with the specifications and limitations of hardware and software of the given hyper-spectral imaging and analysis application. Clearly, actual levels of accuracy, precision, sensitivity, and speed (time scale), of a given hyper-spectral imaging and analysis application are measured, evaluated, compared, and analyzed, relative to known or established criteria and levels of accuracy, precision, sensitivity, and speed (time scale).

As with most activities or/and phenomena, in hyper-spectral imaging and analysis applications, accuracy, precision, sensitivity, and speed (time scale), are often, and usually, not proportional to, or/and synchronized (simultaneous) with, each other. In other words, it is often, and usually, difficult to have a hyper-spectral imaging and analysis application which can be characterized at the same time as being highly accurate, highly precise (reproducible), highly sensitive, and of high speed (short time scale). Often, and usually, high accuracy is achieved at the expense of achieving high precision or/and at the expense of achieving high sensitivity or/and at the expense of achieving high speed (short time scale). Similarly, high speed (short time scale) is often, and usually, achieved at the expense of achieving high accuracy or/and at the expense of achieving high precision or/and at the expense of achieving high sensitivity. In practice, any given hyper-spectral imaging and analysis application is characterized by some combination of variable levels of accuracy, precision, sensitivity, and speed (time scale), in accordance with the specifications and limitations of hardware and software of the given hyper-spectral imaging and analysis application.

One may consider a given hyper-spectral imaging and analysis application as being comprised of two separate, but integrated, domains or stages of main activities or procedures, as follows. The first domain or stage of main activities or procedures is based on, and involves, generating and collecting of the hyper-spectral images. The second domain or stage of main activities or procedures is based on, and involves, processing and analyzing the generated and collected hyper-spectral image data and information. In general, each of these two domains or stages of a hyper-spectral imaging and analysis application can be characterized by various different levels of accuracy, precision (reproducibility), sensitivity, and speed.

Accuracy, precision (reproducibility), sensitivity, and speed (time scale), of the first domain or stage of a hyper-spectral imaging and analysis application are primarily (i.e., not exclusively) determinable and controllable by the types, kinds, quantity, and quality, of ‘physical’ hardware equipment and instrumentation which comprise a given hyper-spectral imaging and analysis system, device, or apparatus. Accuracy, precision (reproducibility), sensitivity, and speed (time scale), of the second domain or stage of a hyper-spectral imaging and analysis application are primarily (i.e., not exclusively) determinable and controllable by the types, kinds, quantity, and quality, of (computer) ‘software’ which is used for implementing and operating a given hyper-spectral imaging and analysis system, device, or apparatus. Such software includes operatively connected and functioning written or printed data, in the form of software programs, routines, sub-routines, symbolic languages, code, instructions or protocols, algorithms, or/and combinations thereof. Clearly, in essentially all hyper-spectral imaging and analysis applications the just described two domains or stages of main activities or procedures are fully integrated, therefore, in theory, and in practice, accuracy, precision (reproducibility), sensitivity, or/and speed (time scale), of the first domain or stage affects, and is affected by, accuracy, precision (reproducibility), sensitivity, or/and speed (time scale), of the second domain or stage, and vice versa.

The scope of application of embodiments of the present invention is directed to, and focused on, the preceding stated second domain or stage of main activities or procedures of a hyper-spectral imaging and analysis application, i.e., being based on, and involving, processing and analyzing generated and collected hyper-spectral image data and information of the imaged object(s) (and components thereof), for an ultimate objective of analyzing and classifying the imaged object(s) (and components thereof). More specifically, wherein the processing and analyzing of hyper-spectral image data and information are based on, and involve, an integrated combination of: (i) real time or/and non-real time automatic (i.e., computerized) data and information manipulating, handling, or/and moving, types of procedures or/and operations, and (ii) real time or/and non-real time automatic (i.e., computerized) data and information analyzing, identifying (recognizing), discriminating, comparing, filtering, sorting, quantifying, characterizing, and classifying, types of procedures or/and operations.

Significant on-Going Problems and Limitations of Processing and Analyzing Hyper-Spectral Image Data and Information

As stated hereinabove, prior art includes a plethora of teachings of hyper-spectral imaging and analysis, in general, generating and collecting hyper-spectral images, and, processing and analyzing hyper-spectral image data and information, in particular. However, significant on-going problems and limitations of processing and analyzing hyper-spectral image data and information are usually based on, involve, or/and are associated with, the theoretical or/and practical difficulties and complexities that arise when performing, or attempting to perform, the varied and numerous data and information processing and analyzing procedures or/and operations with some combination of exceptionally high accuracy, ‘or/and’ high precision (reproducibility), ‘or/and’ high sensitivity, ‘or/and’ at high speed (short time scale), be it during real time or during non-real time, in an optimum or highly efficient manner. Exceptional difficulties and complexities arise when performing, or attempting to perform, the varied and numerous data and information processing and analyzing procedures or/and operations with the ‘ultimate’ combination of exceptionally high accuracy, ‘and’ high precision (reproducibility), ‘and’ high sensitivity, ‘and’ at high speed (short time scale), all at the same time (i.e., simultaneously), be it during real time or during non-real time, in an optimum or highly efficient manner.

There exists a wide variety of numerous different exemplary specific cases of hyper-spectral imaging and analysis applications wherein theoretical or/and practical difficulties and complexities arise when performing, or attempting to perform, the varied and numerous data and information processing and analyzing procedures or/and operations with some combination of exceptionally high accuracy, or/and high precision (reproducibility), or/and high sensitivity, or/and at high speed (short time scale), or, all at the same time (i.e., simultaneously), be it during real time or during non-real time, in an optimum or highly efficient manner. For background purposes, only a few such exemplary specific cases of hyper-spectral imaging and analysis applications are described herein, as follows.

As described hereinabove, a scene which is imaged in one or more hyper-spectral images, via one or more fields of view, includes or contains a plurality, collection, or ensemble, of several objects (i.e., entities, materials, substances, or structures), wherein, there exists a number of objects which are objects of interest (targets), or/and objects of non-interest (background). Typically, each hyper-spectrally imaged scene of a sample of matter includes or contains a distribution of different relative numbers (i.e., ratios, proportions) of objects of interest (targets), or/and objects of non-interest (background). For example, a given hyper-spectrally imaged scene may include or contain a distribution of a relatively small number of objects of interest (targets), and a relatively large number of objects of non-interest (corresponding to a relatively high or ‘noisy’ background). Conversely, a given imaged scene may include or contain a distribution of a relatively large number of objects of interest (targets), and a relatively small number of objects of non-interest (corresponding to a relatively low or ‘quiet’ background).

Moreover, for example, there are many hyper-spectral imaging and analysis applications wherein the majority of hyper-spectrally imaged scenes include or contain a relatively ‘exceptionally’ small number of objects of interest (targets) compared to a relatively large number of objects of non-interest (high or noisy background). For example, such applications are wherein the number of objects of interest (targets), relative to the number of all objects [of interest (target) and of non-interest (background)] of (included or contained in) a hyper-spectrally imaged scene, corresponds to a ratio or proportion as low as 1% [1 part per hundred (pph)], or 10⁻¹% [1 part per thousand (ppt)], or 10⁻⁴% [1 part per million (ppm)], 10⁻⁷% [1 part per billion (ppb)], or even as low as 10⁻¹⁰% [1 part per trillion (pptr)].

In addition to hyper-spectrally imaged scenes including or containing distributions of different relative numbers (ratios, proportions) of different types, categories, or classes, of objects, each hyper-spectrally imaged object (entity, material, substance) is definable and characterizable by a set of a wide variety of numerous possible biophysicochemical properties, characteristics, and behavior. For example, in a given hyper-spectrally imaged scene, there may exist different relative numbers, and types kinds, of objects whose ‘hyper-spectral’ image data and information (particularly including, for example, emission spectra corresponding to spectral representations in the form of spectral fingerprint or signature pattern types of identification and characterization), are quite similar, or even nearly identical, i.e., barely distinguishable or resolvable, but whose ‘biophysicochemical’ data and information (in terms of properties, characteristics, or/and behavior), are significantly different, and not at all similar or nearly identical, i.e., easily distinguishable or resolvable, or vice versa.

Regardless of the actual distributions of the different relative numbers (i.e., ratios, proportions) of objects of interest (targets) and objects of non-interest (background) in hyper-spectrally imaged scenes of a sample of matter, any hyper-spectral imaging and analysis application ultimately involves the need for identifying, distinguishing, and resolving, the objects of interest (targets) from among themselves, and from among the objects of non-interest (background), in the hyper-spectrally imaged scenes. This involves the need for identifying, distinguishing, and resolving, the hyper-spectral image data and information of the objects of interest (targets) from among themselves, and from among the hyper-spectral image data and information of the objects of non-interest (background). Moreover, there is also the need for performing such identifying, distinguishing, and resolving, procedures and operations in relation to the biophysicochemical data and information of the objects of interest (targets) and of the objects of non-interest (background), in the hyper-spectrally imaged scenes.

In hyper-spectral imaging, processing and analyzing hyper-spectral image data and information is performed according to various different speeds or time scales. For example, there are many hyper-spectral imaging and analysis applications which, by definition, and in accordance with the particular characteristics, needs, or requirements, of such applications, necessarily require that processing and analyzing hyper-spectral image data and information be performed at exceptionally high speeds, for example, on the order of thousands or millions of data or/and information items per second, or, equivalently, at exceptionally short time scales, for example, on the order of milliseconds (msec) or microseconds (μsec) per data or/and information operation. This is particularly the case for hyper-spectral imaging and analysis applications which involve automatically generating and collecting relatively large numbers (e.g., on the order of tens or hundreds of thousands, or even millions) of individual hyper-spectral images (each containing a plurality of emission spectra, spectral fingerprints, and spectral patterns), typically, via a relatively large number of different fields of view, of a relatively large number of scenes, wherein each scene includes or contains a single object, or a plurality, collection, or ensemble, of several objects (and components thereof).

For each of the preceding briefly described exemplary specific cases of hyper-spectral imaging and analysis applications, various theoretical or/and practical difficulties and complexities typically arise when performing, or attempting to perform, the varied and numerous data and information processing and analyzing procedures or/and operations with some combination of exceptionally high accuracy, or/and high precision (reproducibility), or/and high sensitivity, or/and at high speed (short time scale), be it during real time (i.e., in-line or on-line) or during non-real time (i.e., off-line), in an optimum or highly efficient manner.

In spite of the various teachings and practices of hyper-spectral imaging and analysis, in general, generating and collecting hyper-spectral images, and, processing and analyzing hyper-spectral image data and information, in particular, and in view of the various theoretical or/and practical difficulties and complexities that typically arise when performing, or attempting to perform, the varied and numerous data and information processing and analyzing procedures or/and operations required for analyzing and classifying imaged objects (and components thereof), there exists an on-going need for overcoming the various and numerous significant on-going problems and limitations associated with analyzing and classifying imaged objects, by developing and practicing improved or/and new methods for analyzing and classifying objects via hyper-spectral imaging and analysis. There is thus a need for, and it would be highly advantageous to have a method of analyzing and classifying objects via hyper-spectral imaging and analysis.

### SUMMARY OF THE INVENTION

The present invention relates to hyper-spectral imaging and analysis, in general, generating and collecting hyper-spectral images, and, processing and analyzing hyper-spectral image data and information, in particular. More particularly, the present invention relates to a method of analyzing and classifying objects via hyper-spectral imaging and analysis.

The present invention is generally applicable for on-line (e.g., real time or near-real time) or off-line analyzing and classifying essentially any type or kind of biological, physical, or/and chemical, (i.e., biophysicochemical) object (entity, material, substance, or structure), wherein the object is composed or made up of essentially any type, kind, and number of species or components, which in turn, are made up of essentially any type, kind, and number of organic or/and inorganic materials or substances. Some embodiments of the present invention are particularly applicable for analyzing and classifying objects that are included in agricultural products (e.g., plant matter, in raw or processed (finished) form), in environmental matter (e.g., contaminated air (aerosol), water, or ground), in food products (and raw materials thereof), in pharmaceutical products (and raw materials thereof), or in aerial observations or views of air, land (ground), or water (such as of polluted air, water, or land (ground)). The present invention is generally applicable to essentially any field or area of technology which involves analyzing and classifying objects. The present invention is generally applicable to remote sensing of objects which involves analyzing and classifying the objects. The present invention provides the capability of achieving the ‘ultimate’ combination of the highly desirable object analysis and classification performance parameters of high accuracy, ‘and’ high precision (high reproducibility), ‘and’ high resolution, ‘and’ high sensitivity, ‘and’ at high speed (short time scale), all at the same time (i.e., simultaneously), be it during on-line or off-line, in an optimum and highly efficient manner.

The scope of application of embodiments of the present invention is directed to, and focused on, the domain or stage of main activities or procedures of a hyper-spectral imaging and analysis application, i.e., being based on, and involving, processing and analyzing generated and collected hyper-spectral image data and information. More specifically, wherein the processing and analyzing of hyper-spectral image data and information are based on, and involve, an integrated combination of: (i) real time or/and non-real time automatic (i.e., computerized) data and information manipulating, handling, or/and moving, types of procedures or/and operations, and (ii) real time or/and non-real time automatic (i.e., computerized) data and information analyzing, identifying (recognizing), discriminating, comparing, filtering, sorting, quantifying, characterizing, and classifying, types of procedures or/and operations.

Embodiments of the method of the present invention are implementable or operable, during real time (i.e., in-line or on-line) or/and during non-real time (i.e., off-line), for optimally and highly efficiently, integrating the two main activities of processing, and analyzing, hyper-spectral image data and information, namely, (i) automatic (i.e., computerized) data and information manipulating, handling, or/and moving, types of procedures or/and operations, and, (ii) automatic (i.e., computerized) data and information analyzing, identifying (recognizing), discriminating, comparing, filtering, sorting, quantifying, characterizing, and classifying, types of procedures or/and operations. Moreover, embodiments of the method of the present invention are implementable or operable for integrating the varied and numerous hyper-spectral image data and information processing and analyzing procedures or/and operations with the ‘ultimate’ combination of exceptionally high accuracy, ‘and’ high precision (reproducibility), ‘and’ high sensitivity, ‘and’ at high speed (short time scale), all at the same time (i.e., simultaneously), be it during real time or during non-real time, in an optimum or highly efficient manner.

Additionally, embodiments of the method of the present invention are implementable or operable for achieving the main goal of analyzing and classifying objects, by relating and translating the hyper-spectral image data and information of imaged objects to micro scale or/and macro scale (qualitative or/and quantitative) biological, physical, or/and chemical, (biophysicochemical) characteristics, properties, and behavior, of the imaged objects (and components thereof) which are readily interpretable, understandable, and further usable, by an operator (observer, viewer, analyzer, or/and controller) of a process involving the imaged objects.

Additionally, embodiments of the method of the present invention are implementable or operable for being generally applicable to analyzing and classifying essentially any type, kind, or number, of objects (entities, materials, substances, or structures), as part of a scene, which are subjectable to a hyper-spectral imaging process or technique. Moreover, wherein the objects are definable and characterizable by a set of a wide variety of numerous possible biophysicochemical properties, characteristics, and behavior, and species or components.

Additionally, embodiments of the method of the present invention are implementable or operable for being generally applicable to analyzing and classifying essentially any type, kind, or number, of objects (entities, materials, substances, or structures), including essentially any type(s) of species or components having any particulate or/and non-particulate type of two-dimensional or/and three-dimensional topological, morphological, and geometrical, configuration, shape, or form, and being composed of essentially any number and type(s) of biophysicochemical material(s) or substance(s).

Additionally, embodiments of the method of the present invention are implementable or operable for being generally applicable to analyzing and classifying objects by processing and analyzing hyper-spectral image data and information of hyper-spectral images of the objects which are generated and collected from the objects emitting electromagnetic radiation having wavelengths (or frequencies, energies), associated with different portions or bands, or bands therein, of an entire spectrum emitted by the objects, such as the ultra-violet (UV) band, the visible (VIS) band, the infra-red (IR) band, and the deep infra-red band.

Additionally, embodiments of the method of the present invention are implementable or operable for being generally applicable to analyzing and classifying objects by processing and analyzing hyper-spectral image data and information of hyper-spectral imaging and analysis applications involving automatically generating and collecting relatively large numbers (e.g., on the order of hundreds, thousands, or millions) of individual hyper-spectral images (each containing a plurality of emission spectra, spectral fingerprints, and spectral patterns), typically, via a plurality of different fields of view, of a plurality of scenes, wherein each scene includes or contains a single object, or a plurality, collection, or ensemble, of several objects (i.e., entities, materials, substances, or structures).

Additionally, embodiments of the method of the present invention are implementable or operable for being generally applicable to analyzing and classifying objects by processing and analyzing hyper-spectral image data and information of hyper-spectral imaging and analysis applications wherein the majority of imaged scenes include or contain an exceptionally relatively small number of objects of interest (targets) compared to a relatively large number of objects of non-interest (high or noisy background). For example, such cases wherein the fraction or concentration of the objects of interest (targets), relative to all objects [of non-interest (background) and of interest (targets)] of (included or contained in) an imaged scene, corresponds to as low as 1% [1 part per hundred (pph)], or 10⁻¹% [1 part per thousand (ppt)], or 10⁻⁴% [1 part per million (ppm)], 10⁻⁷% [1 part per billion (ppb)], or even as low as 10⁻¹⁰% [1 part per trillion (pptr)].

Additionally, embodiments of the method of the present invention are implementable or operable for being generally applicable to analyzing and classifying objects by processing and analyzing hyper-spectral image data and information of hyper-spectral imaging and analysis applications which require distinguishing or resolving quite similar, or even nearly identical, hyper-spectral image data, information, and parameters, in relation to significantly different biophysicochemical data, information, and parameters, of objects in imaged scenes.

Additionally, embodiments of the method of the present invention are implementable or operable for being generally applicable to analyzing and classifying objects by processing and analyzing hyper-spectral image data and information of hyper-spectral imaging and analysis applications according to various different speeds or time scales. For example, wherein such hyper-spectral imaging and analysis applications which, by definition, and in accordance with the particular characteristics, needs, or requirements, necessarily require that processing and analyzing hyper-spectral image data and information be performed at exceptionally high speeds, for example, on the order of thousands or millions of data or/and information items per second, or, equivalently, at exceptionally short time scales, for example, on the order of milliseconds (msec) or microseconds (μsec) per data or/and information operation.

Additionally, embodiments of the method of the present invention are implementable or operable for being generally applicable to analyzing and classifying objects by processing and analyzing hyper-spectral image data and information of hyper-spectral images of objects which are generated and collected by using various different types or kinds of hyper-spectral imaging systems, devices, or/and apparatuses, which are operable during real time (i.e., in-line or on-line) or/and during non-real time (i.e., off-line). Accordingly, embodiments of the method of the present invention are implementable or operable for being generally applicable to, and integratable with, various different types or kinds of physical hardware equipment and instrumentation, and, (computer) software, which comprise a given hyper-spectral imaging system, device, or apparatus, which is operable during real time (i.e., in-line or on-line) or/and during non-real time (i.e., off-line).

Additionally, embodiments of the method of the present invention are readily commercially applicable to a wide variety of different fields and areas of technology, and associated applications thereof, which either are, or may be, based on, involve, or benefit from the use of, hyper-spectral imaging, in general, generating and collecting hyper-spectral images, and, processing and analyzing hyper-spectral image data and information, in particular, for an ultimate objective of analyzing and classifying objects.

Embodiments of the method of the present invention successfully address and overcome various significant problems and limitations, and widen the scope, of presently known techniques and methods of analyzing and classifying objects, via hyper-spectral imaging and analysis.

Thus, according to a main aspect of some embodiments of the present invention, there is provided a method of analyzing and classifying an object via hyper-spectral imaging and analysis, the method comprising: (a) generating and collecting respective reference objects and object hyper-spectral image data and information, of: (i) a set of reference objects related to or/and associated with the object, and (ii) the object, respectively, via a hyper-spectral imaging and analysis system; (b) forming and storing: (i) a global reference database associated with the reference objects hyper-spectral image data and information, and (ii) an object database associated with the object hyper-spectral image data and information, respectively, by processing and analyzing the reference objects and the object hyper-spectral image data and information, via a data-information processing and analyzing unit of the hyper-spectral imaging and analysis system; (c) forming and storing a sub-global reference database associated with a sub-set of the reference objects hyper-spectral image data and information and with a sub-set of the global reference database, by processing and analyzing the reference objects and the object hyper-spectral image data and information, and, the global reference database and the object database, via the data-information processing and analyzing unit; and (d) identifying and storing an object classification, by processing and analyzing the object database and the sub-global reference database, via the data-information processing and analyzing unit.

According to some embodiments of the present invention, the forming and storing the sub-global reference database includes forming, and storing sets of reference object feature functions and object feature functions.

According to some embodiments of the present invention, each reference object feature function is defined in terms of, related to, or/and associated with, elements of the global reference database.

According to some embodiments of the present invention, each object feature function is defined in terms of, related to, or/and associated with, elements of the object database.

According to some embodiments of the present invention, each reference object feature function is a function of one or more hyper-spectral imaging parameters selected from the group consisting of reference object emission wavelengths, reference object emission frequencies, and reference object emission energies, of the hyper-spectrally imaged reference object.

According to some embodiments of the present invention, each reference object feature function is a function of one or more hyper-spectral imaging parameters selected from the group consisting of reference object image shapes, and reference object image qualities.

According to some embodiments of the present invention, each reference object feature function is related to or/and associated with one or more particular biophysicochemical properties, characteristics, or behaviors, of the reference object.

According to some embodiments of the present invention, the reference object feature function is related to or/and associated with one or more particular biophysicochemical properties, characteristics, or behaviors, of the reference object.

According to some embodiments of the present invention, the reference object feature function is a linear or/and non-linear combination of the hyper-spectral imaging parameters.

According to some embodiments of the present invention, the reference object feature function is a ratio of two of the hyper-spectral imaging parameters.

According to some embodiments of the present invention, the reference object feature function is a ratio of two different hyper-spectral imaging parameters of a hyper-spectrally imaged reference object, which are identified and selected from two corresponding different specific locations in a hyper-spectral image of a reference object.

According to some embodiments of the present invention, the ratio form of the reference object feature function is related to or/and associated with one biophysicochemical property, characteristic, or behavior, of the reference object.

According to some embodiments of the present invention, the ratio form of the reference object feature function is related to or/and associated with two different biophysicochemical properties, characteristics, or behaviors, of the reference object.

According to some embodiments of the present invention, each object feature function is a function of one or more hyper-spectral imaging parameters selected from the group consisting of object emission wavelengths, object emission frequencies, and object emission energies, of the hyper-spectrally imaged object.

According to some embodiments of the present invention, the object feature function is a function of one or more hyper-spectral imaging parameters selected from the group consisting of object image shapes, and object image qualities.

According to some embodiments of the present invention, each object feature function is related to or/and associated with one or more particular biophysicochemical properties, characteristics, or behaviors, of the object.

According to some embodiments of the present invention, the object feature function is a linear or/and non-linear combination of the hyper-spectral imaging parameters.

According to some embodiments of the present invention, the object feature function is a ratio of two of the hyper-spectral imaging parameters.

According to some embodiments of the present invention, the object feature function is a ratio of two different hyper-spectral imaging parameters of a hyper-spectrally imaged reference object, which are identified and selected from two corresponding different specific locations in a hyper-spectral image of the object.

According to some embodiments of the present invention, the ratio form of the object feature function is related to or/and associated with one biophysicochemical property, characteristic, or behavior, of the object.

According to some embodiments of the present invention, the ratio form of the object feature function is related to or/and associated with two different biophysicochemical properties, characteristics, or behaviors, of the object.

According to some embodiments of the present invention, the identifying and storing the object classification includes comparing values of the reference object feature functions to values of the object feature functions, for identifying the values which are identically or approximately equal, and assigning such values to the object classification.

Some embodiments of the present invention are implemented by performing steps or procedures, and sub-steps or sub-procedures, in a manner selected from the group consisting of manually, semi-automatically, fully automatically, and a combination thereof, involving use and operation of system units, system sub-units, devices, assemblies, sub-assemblies, mechanisms, structures, components, and elements, and, peripheral equipment, utilities, accessories, and materials. Moreover, according to actual steps or procedures, sub-steps or sub-procedures, system units, system sub-units, devices, assemblies, sub-assemblies, mechanisms, structures, components, and elements, and, peripheral equipment, utilities, accessories, and materials, used for implementing a particular embodiment of the disclosed invention, the steps or procedures, and sub-steps or sub-procedures, are performed by using hardware, software, or/and an integrated combination thereof, and the system units, sub-units, devices, assemblies, sub-assemblies, mechanisms, structures, components, and elements, and, peripheral equipment, utilities, accessories, and materials, operate by using hardware, software, or/and an integrated combination thereof.

For example, software used, via an operating system, for implementing some embodiments of the present invention can include operatively interfaced, integrated, connected, or/and functioning written or/and printed data, in the form of software programs, software routines, software sub-routines, software symbolic languages, software code, software instructions or protocols, software algorithms, or a combination thereof. For example, hardware used for implementing some embodiments of the present invention can include operatively interfaced, integrated, connected, or/and functioning electrical, electronic or/and electromechanical system units, sub-units, devices, assemblies, sub-assemblies, mechanisms, structures, components, and elements, and, peripheral equipment, utilities, accessories, and materials, which may include one or more computer chips, integrated circuits, electronic circuits, electronic sub-circuits, hard-wired electrical circuits, or a combination thereof, involving digital or/and analog operations. Some embodiments of the present invention can be implemented by using an integrated combination of the just described exemplary software and hardware.

In exemplary embodiments of the present invention, steps or procedures, and sub-steps or sub-procedures, can be performed by a data processor, such as a computing platform, for executing a plurality of instructions. Optionally, the data processor includes volatile memory for storing instructions or/and data, or/and includes non-volatile storage, for example, a magnetic hard-disk or/and removable media, for storing instructions or/and data. Optionally, exemplary embodiments of the present invention include a network connection. Optionally, exemplary embodiments of the present invention include a display device and a user input device, such as a keyboard or/and ‘mouse’.

### BRIEF DESCRIPTION OF THE DRAWINGS

Some embodiments of the present invention are herein described, by way of example only, with reference to the accompanying drawings. With specific reference now to the drawings in detail, it is stressed that the particulars shown are by way of example and for purposes of illustrative description of some embodiments of the present invention. In this regard, the description taken together with the accompanying drawings make apparent to those skilled in the art how some embodiments of the present invention may be practiced. In the drawings:

FIG. 1 is a (block-type) flow diagram of an exemplary embodiment of the main steps or procedures of the method of analyzing and classifying objects via hyper-spectral imaging and analysis, in accordance with the present invention; and

FIG. 2 is a schematic flow-type diagram illustrating selected main aspects and features of the main steps or procedures of the method of analyzing and classifying objects via hyper-spectral imaging and analysis shown in FIG. 1, in accordance with the present invention.

### DESCRIPTION OF SPECIFIC EMBODIMENTS OF THE INVENTION

The present invention relates to hyper-spectral imaging and analysis, in general, generating and collecting hyper-spectral images, and, processing and analyzing hyper-spectral image data and information, in particular. More particularly, the present invention relates to a method of analyzing and classifying objects via hyper-spectral imaging and analysis.

The present invention is generally applicable for on-line (e.g., real time or near-real time) or off-line analyzing and classifying essentially any type or kind of biological, physical, or/and chemical, (i.e., biophysicochemical) object (entity, material, substance, or structure), wherein the object is composed or made up of essentially any type or kind of organic or/and inorganic materials or substances. Some embodiments of the present invention are particularly applicable for analyzing and classifying objects that are included in agricultural products (e.g., plant matter, in raw or processed (finished) form), in environmental matter (e.g., contaminated air (aerosol), water, or ground), in food products (and raw materials thereof), in pharmaceutical products (and raw materials thereof), or in aerial observations or views of air, land (ground), or water (such as of polluted air, water, or land (ground)). The present invention is generally applicable to essentially any field or area of technology which involves analyzing and classifying objects. The present invention is generally applicable to remote sensing of objects which involves analyzing and classifying the objects. The present invention provides the capability of achieving the ‘ultimate’ combination of the highly desirable object analysis and classification performance parameters of high accuracy, ‘and’ high precision (high reproducibility), ‘and’ high resolution, ‘and’ high sensitivity, ‘and’ at high speed (short time scale), all at the same time (i.e., simultaneously), be it during on-line or off-line, in an optimum and highly efficient manner.

The scope of application of embodiments of the present invention is directed to, and focused on, the domain or stage of main activities or procedures of a hyper-spectral imaging and analysis application, i.e., being based on, and involving, processing and analyzing generated and collected hyper-spectral image data and information. More specifically, wherein the processing and analyzing of hyper-spectral image data and information are based on, and involve, an integrated combination of: (i) real time or/and non-real time automatic (i.e., computerized) data and information manipulating, handling, or/and moving, types of procedures or/and operations, and (ii) real time or/and non-real time automatic (i.e., computerized) data and information analyzing, identifying (recognizing), discriminating, comparing, filtering, sorting, quantifying, characterizing, and classifying, types of procedures or/and operations.

A main aspect of some embodiments of the present invention is provision of a method of analyzing and classifying an object via hyper-spectral imaging and analysis, the method including the following main steps or procedures, and, components and functionalities thereof: (a) generating and collecting respective reference objects and object hyper-spectral image data and information, of: (i) a set of reference objects related to or/and associated with the object, and (ii) the object, respectively, via a hyper-spectral imaging and analysis system; (b) forming and storing: (i) a global reference database associated with the reference objects hyper-spectral image data and information, and (ii) an object database associated with the object hyper-spectral image data and information, respectively, by processing and analyzing the reference and the object hyper-spectral image data and information, via a data-information processing and analyzing unit of the hyper-spectral imaging and analysis system; (c) forming and storing a sub-global reference database associated with a sub-set of the reference objects hyper-spectral image data and information and with a sub-set of the global reference database, by processing and analyzing the reference objects and the object hyper-spectral image data and information, and, the global reference database and the object database, via the data-information processing and analyzing unit; and (d) identifying and storing an object classification, by processing and analyzing the object database and the sub-global reference database, via the data-information processing and analyzing unit.

Embodiments of the present invention successfully address and overcome various significant problems and limitations, and widen the scope, of presently known techniques and methods of analyzing and classifying objects, via hyper-spectral imaging and analysis.

It is to be understood that the present invention is not limited in its application to the details of the order or sequence, and number, of steps or procedures, sub-steps or sub-procedures, of operation or implementation of some embodiments of the method set forth in the following illustrative description, and accompanying drawings, unless otherwise specifically stated herein. The present invention can be practiced or implemented according to various other alternative embodiments and in various other alternative ways.

It is also to be understood that all technical and scientific words, terms, or/and phrases, used herein throughout the present disclosure have either the identical or similar meaning as commonly understood by one of ordinary skill in the art to which this invention belongs, unless otherwise specifically defined or stated herein. Phraseology, terminology, and, notation, employed herein throughout the present disclosure are for the purpose of description and should not be regarded as limiting. For example, the following illustrative description generally refers to the term ‘objects’, in order to illustrate implementation of exemplary embodiments of the present invention. Herein, the term ‘object’ as used for illustratively describing exemplary embodiments of the present invention, is considered synonymous with, at least part of an entity, material, substance, or structure, which, singly or in combination with other objects (entities, materials, substances, or structures), typically as part of a scene, is subjectable to a hyper-spectral imaging process or technique. In general, such an object is composed or made up of essentially any type, kind, and number of species or components, which in turn, are made up of essentially any type, kind, and number of organic or/and inorganic materials or substances. In general, such an object is definable and characterizable by a set of a wide variety of numerous possible biophysicochemical properties, characteristics, and behavior, and, species or components.

Moreover, all technical and scientific words, terms, or/and phrases, introduced, defined, described, or/and exemplified, in the above Field and Background sections, are equally or similarly applicable in the illustrative description of the embodiments, examples, and appended claims, of the present invention. Immediately following are selected definitions and exemplary usages of words, terms, or/and phrases, which are used throughout the illustrative description of some embodiments, examples, and appended claims, of the present invention, and are especially relevant for understanding thereof.

Each of the following terms written in singular grammatical form: ‘a’, ‘an’, and ‘the’, as used herein, may also refer to, and encompass, a plurality of the stated entity or object, unless otherwise specifically defined or stated herein, or, unless the context clearly dictates otherwise. For example, the phrases: ‘a unit’, ‘a device’, ‘an assembly’, ‘a mechanism’, ‘a component’, and ‘an element’, as used herein, may also refer to, and encompass, a plurality of units, a plurality of devices, a plurality of assemblies, a plurality of mechanisms, a plurality of components, and a plurality of elements, respectively. For example, the phrase ‘an object’ may also refer to, and encompass, a plurality of objects, or/and mixtures thereof.

Each of the following terms: ‘includes’, ‘including’, ‘has’, ‘having’, ‘comprises’, and ‘comprising’, and, their linguistic/grammatical variants, derivatives, or/and conjugates, as used herein, means ‘including, but not limited to’.

Each of the phrases ‘consisting of’ and ‘consists of’, as used herein, means ‘including and limited to’.

The term ‘real-time’, as used herein, generally refers to essentially any action, activity, step, procedure, process, or operation, which is (automatically or/and manually) performed or implemented at the same time, or at nearly the same time, with negligible or insignificant time lag, that a targeted (monitored, tracked, observed) event or situation of interest occurs or takes place.

The term ‘about’, as used herein, refers to ±10% of the stated numerical value.

Throughout the illustrative description of some embodiments, the examples, and the appended claims, of the present invention, a numerical value of a parameter, feature, object, or dimension, may be stated or described in terms of a numerical range format. It is to be fully understood that the stated numerical range format is provided for illustrating implementation of some embodiments of the present invention, and is not to be understood or construed as inflexibly limiting the scope of embodiments of the present invention.

Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably. For example, for stating or describing the numerical range of room temperature, the phrase ‘room temperature refers to a temperature in a range of between about 20° C. and about 25° C.’, is considered equivalent to, and meaning the same as, the phrase ‘room temperature refers to a temperature in a range of from about 20° C. to about 25° C.’.

Steps or procedures, sub-steps or sub-procedures, equipment, and materials, as well as operation and implementation, of exemplary embodiments, alternative embodiments, specific configurations, and, additional and optional aspects, characteristics, or features, thereof, of the method of analyzing and classifying objects via hyper-spectral imaging and analysis, according to the present invention, are better understood with reference to the following illustrative description and accompanying drawings. Throughout the following illustrative description and accompanying drawings, same reference notation and terminology (i.e., numbers, letters, or/and symbols), refer to same components, elements, and parameters.

According to a main aspect of some embodiments of the present invention, there is provision of a method of analyzing and classifying an object via hyper-spectral imaging and analysis.

### Applicable Objects Subjectable to the Hyper-Spectral Imaging Process or Technique

Embodiments of the method of the present invention are implementable or operable for being generally applicable to analyzing and classifying essentially any type, kind, or number, of objects (entities, materials, substances, or structures), including essentially any type(s) of species or components having any particulate or/and non-particulate type of two-dimensional or/and three-dimensional topological, morphological, and geometrical, configuration, shape, or form, and being composed of essentially any number and type(s) of biophysicochemical material(s) or substance(s).

As stated hereinabove in the Background section, in the context of the field and art of the present invention, herein, the term ‘object’ generally refers to, and is considered synonymous with, at least part of an entity, material, substance, or structure, which, singly or in combination with other objects (entities, materials, substances, or structures), typically as part of a scene, is subjectable to a hyper-spectral imaging process or technique. In general, such an object is composed or made up of essentially any type, kind, and number of species or components, which in turn, are made up of essentially any type, kind, and number of organic or/and inorganic materials or substances. In general, such an object is definable and characterizable by a set of a wide variety of numerous possible biophysicochemical properties, characteristics, and behavior, and, species or components, only a few examples of which are briefly described as follows.

Some embodiments of the present invention are particularly applicable for analyzing and classifying objects that are included in agricultural products (e.g., plant matter, in raw or processed (finished) form), in environmental matter (e.g., contaminated air (aerosol), water, or ground), in food products (and raw materials thereof), in pharmaceutical products (and raw materials thereof), or in aerial observations or views of air, land (ground), or water (such as of polluted air, water, or land (ground)).

For example, in general, such an object is composed of any type, kind, or number of organic or/and inorganic chemical species or components. In general, such an object either is, or is derived from, living matter (e.g., plant, animal, or human, matter which is living), or/and non-living matter (e.g., mineral, plant, animal, or human, matter which is non-living). Such an object which either is, or is derived from, plant, animal, or human, matter, either is, or is derived from, a biological moiety, where, herein, a biological moiety generally refers to a part or portion (of indefinite size or/and structure) of a biological entity, and wherein a biological entity refers to an entity, a material, a substance, or a structure, originating or derived from a biological (human, animal, or plant) organism. In general, a given object is part of, or contained in, a gaseous, liquid, or/and solid, phase or form. In general, a given object either may be, or may contain, particulate matter or particulate-like matter (i.e., matter having particle-like features, characteristics, properties, and behavior). In general, at a given instant of time, a given object is in a ‘static’ (fixed or immobile) state, or, in a ‘dynamic’ (moving or mobile) state, with respect to a fixed reference point defined by a set of fixed reference position coordinates (e.g., x, y, and z, position coordinates) within a scene of the object.

Object Interaction with Electromagnetic Radiation During Hyper-Spectral Imaging

In general, when electromagnetic radiation, for example, in the form of light such as that supplied by the sun, or by a man-made imaging type of illuminating or energy source, such as that used during hyper-spectral imaging, is incident upon an object, the electromagnetic radiation is affected by one or more of the biological, physical, or/and chemical, (biophysicochemical) species or components making up the object, by any combination of electromagnetic radiation absorption, diffusion, reflection, diffraction, scattering, or/and transmission, mechanisms. Moreover, an object whose composition includes organic chemical species or components, ordinarily exhibits some degree or extent of fluorescent or/and phosphorescent properties, characteristics, and behavior, when illuminated by some type of electromagnetic radiation or light, such as ultra-violet (UV), visible (VIS), or infrared (IR), types of light. The affected electromagnetic radiation, in the form of diffused, reflected, diffracted, scattered, or/and transmitted, electromagnetic radiation emitted by, or/and emerging from, the object (and components thereof), is directly and uniquely related to, and can be correlated with, the biological, physical, chemical, (biophysicochemical) properties, characteristics, and behavior, of the object, in general, and of the biological, physical, or/and chemical, (biophysicochemical) species or components making up the object, in particular, and therefore represents a spectral (‘fingerprint’ or ‘signature’) pattern type of identification and characterization of the object, which is directly applicable for analyzing and classifying the object.

### Applicable Hyper-Spectral Imaging and Analysis Systems, Devices, Apparatuses, and Main Components Thereof

In general, for implementing embodiments of the method of the present invention, the hyper-spectral image data and information are generated and collected during real time (i.e., in-line or on-line) or/and during non-real time (i.e., off-line). During hyper-spectral imaging, an object or objects, typically as part of a scene, is/are exposed to natural or/and man-made electromagnetic radiation, followed by generation and collection of multiple spectral (i.e., hyper-spectral) images, via a single field of view, or via a plurality of fields of view, of the object(s) emitting electromagnetic radiation having wavelengths (or frequencies, energies) associated with different selected (relatively narrow) portions or bands, or bands therein, of an entire spectrum emitted by the object(s).

For example, for implementing embodiments of the method of the present invention, hyper-spectral images of an object or of objects are generated and collected from the object(s) emitting electromagnetic radiation having wavelengths (or frequencies, energies) associated with one or more of the following portions or bands, or bands therein, of an entire spectrum emitted by the object(s): the ultra-violet (UV) band, spanning the wavelength range of about 100-350 nanometers; the visible (VIS) band, spanning the wavelength range of about 400-700 nanometers [blue band: about 400-500 nm, green band: about 500-600 nm, red band: about 600-700 nm]; the infra-red (IR) band, spanning the wavelength range of about 800-1200 nanometers; and the deep infra-red band, spanning the wavelength range of about 3-12 microns. Such hyper-spectral images generated by, and collected from, the imaged object(s), correspond to spectral ‘fingerprint’ or ‘signature’ pattern types of identification and characterization of the imaged object(s), which, subsequently, are processed and analyzed in accordance with embodiments of the method of the present invention.

In general, for implementing embodiments of the method of the present invention, the hyper-spectral image data and information are generated and collected, during real time (in-line or on-line) or/and during non-real time (off-line), by using essentially any type or kind of hyper-spectral imaging system, device, or/and apparatus, which is operable during real time or/and during non-real time. Such a hyper-spectral imaging system, device, or/and apparatus, is/are of appropriate design and construction, and operates, for performing main tasks of generating, detecting, measuring, acquiring, collecting, processing, analyzing, and preferably, displaying, a wide variety of different types of hyper-spectral image data and information.

For performing these tasks, a ‘generalized’ hyper-spectral imaging and analysis system, device, or/and apparatus, preferably, includes as main components: (i) an illuminating unit, for generating and optically supplying electromagnetic radiation to individual objects among a plurality, collection, or ensemble, of several objects (i.e., entities, materials, substances, or structures) of (included or contained in) the surroundings or place of each scene which is imaged in a plurality of hyper-spectral images, via one or more fields of view, for forming illuminated objects; (ii) a hyper-spectral imaging unit, for optically detecting the affected energies or emission beams emitted by, and emerging from, illuminated objects, and for generating optical forms of hyper-spectral images of the illuminated objects of the imaged scenes; (iii) a hyper-spectral image converting unit, for converting the optical forms of the hyper-spectral images to corresponding electronic forms of the hyper-spectral images; and (iv) a data-information processing and analyzing unit, for programming, processing, analyzing, and storing the various data and information, or/and signals thereof, of the units and components thereof, of the hyper-spectral imaging and analysis system, device, or/and apparatus.

Optionally, the hyper-spectral imaging and analysis system, device, or/and apparatus, further includes a synchronizing unit, for synchronizing overall operation and operating parameters of the units and components thereof, of the hyper-spectral imaging and analysis system, device, or/and apparatus, singly, in combination with each other, and, optionally, in combination with peripheral, auxiliary, or/and external, equipment (hardware or/and software) and, operation and operating parameters thereof.

Optionally, the hyper-spectral imaging and analysis system, device, or/and apparatus, further includes an operator workstation unit, for enabling an operator to send operating commands, instructions, and data, to the data-information processing and analyzing unit, as well as to receive data and information therefrom, during real time (in-line or on-line) or/and during non-real time (off-line) operation of the hyper-spectral imaging and analysis system, device, or/and apparatus.

For implementing embodiments of the method of the present invention, during real time (in-line or on-line) or/and during non-real time (off-line), in the above described generalized hyper-spectral imaging and analysis system, device, or/and apparatus, each of the illuminating unit, the hyper-spectral imaging unit, and the hyper-spectral image converting unit, is operatively (electrically or/and electronically) connected to the data-information processing and analyzing unit, and to the other units, as needed, and optionally, to the optional synchronizing unit, or/and to the optional operator workstation unit, via appropriate data and information input/output (I/O) signal paths and junctions.

Each of the several above stated main components, and optional components, of an applicable hyper-spectral imaging and analysis system, device, or/and apparatus, preferably, is of design and construction, and operates, for providing the ‘ultimate’ combination of exceptionally high accuracy, ‘and’ high precision (reproducibility), ‘and’ high sensitivity, ‘and’ at high speed (short time scale), all at the same time (i.e., simultaneously), be it during real time or during non-real time, in an optimum or highly efficient manner. Additionally, each of the several above stated main components, and optional components, of an applicable hyper-spectral imaging and analysis system, device, or/and apparatus, preferably, provides high performance, including, for example, relatively high resolution at high speed (short time scale), along with providing low false positive and false negative error rates.

In general, the hyper-spectral imaging unit is essentially any type of device, mechanism, or assembly, which is capable of operating as just described. For example, the hyper-spectral imaging unit is designed, constructed, and operative, as an optical interferometer, which optically detects affected energy or emission beams, emitted by, and emerging from, illuminated objects, in the form of whole images, and then optically processes the whole images for generating optical forms of hyper-spectral images of the illuminated objects of (included or contained in) the imaged scenes.

For example, the hyper-spectral imaging unit is appropriately designed, constructed, and operative, according to a high performance, high resolution high speed (short time scale) hyper-spectral mode of hyper-spectral imaging and analysis, for example, as illustratively described [22] by the same applicant of the present invention. Such a hyper-spectral imaging unit has spectral and spatial resolutions on the order of less than about 30 nm, for example, on the order of about 5 nm. As disclosed therein, such a hyper-spectral imaging unit involves the use of a specially designed, constructed, and operative, piezoelectric optical interferometer, based on using piezoelectric technology with closed loop control and analysis algorithms, for enabling real time high resolution high speed nanometer accuracy movement of a movable mirror in the optical interferometer, along with using a specially designed and constructed optical interferometer mount as part of the optical interferometer, for achieving high thermo-mechanical stability of mounted optical interferometer components during real time hyper-spectral imaging of objects.

As further disclosed therein, operation of such a hyper-spectral imaging unit involves using a specially designed optical path distance (OPD) calibration procedure, and image processing software algorithms, for enabling high speed (on the order of less than about 100 milliseconds scanning per image) generating of high spectral and spatial resolution (for example, on the order of less than about 5 nm) interferogram images, which in turn would be used for synthesizing and analyzing high resolution highly reproducible three-dimensional hyper-spectral (cube) images of objects of (included or contained in) the imaged scenes.

Alternatively, for example, the hyper-spectral imaging unit is designed, constructed, and operative, as a dispersion prism, which optically detects the affected energies or emission beams emitted by, and emerging from, the illuminated objects, in the form of single lines of a whole image, and then optically processes the single lines of the whole images for generating optical forms of hyper-spectral images of the illuminated objects of the imaged scenes.

The hyper-spectral imaging unit can include components designed, constructed, and operative, according to multiplexing/demultiplexing (demux) fiber optics technology. In particular, an exemplary embodiment of such a hyper-spectral imaging unit includes a ‘detecting’ bundle of a plurality of individual or demultiplexed flexible fiber optic tubes which is operatively connected to an illuminating bundle of a plurality of flexible fiber optic tubes of an illuminating unit. The detecting bundle of flexible fiber optic tubes is positioned relative to the output of the illuminating unit and to objects of (included or contained in) a scene, in a manner such that the detecting bundle of flexible fiber optic tubes detects, receives, and then transmits (forwards), individual or demultiplexed optically detected affected energies or emission beams, emitted by, and emerging from, the illuminated objects, in the form of whole images, or in the form of single lines of a whole image, to other components of the hyper-spectral imaging unit, which then optically process the whole images, or the single lines of whole images, respectively, for generating optical forms of hyper-spectral images of illuminated objects of the imaged scenes.

In the above described generalized hyper-spectral imaging and analysis system, device, or/and apparatus, the hyper-spectral image converting unit is for converting the optical forms of the hyper-spectral images to corresponding electronic forms of the hyper-spectral images of the illuminated objects in the imaged scenes. In general, the hyper-spectral image converting unit is essentially any type of device, mechanism, or assembly, which is capable of operating as just described. For example, the hyper-spectral image converting unit is designed, constructed, and operative, as a plurality of line detectors/cameras, or alternatively, as a CCD (charged coupled detector) type of detector/camera, or alternatively, as a diode array type of detector/camera, each of which converts the optical forms of the hyper-spectral images to corresponding electronic forms of the hyper-spectral images of the illuminated objects in the imaged scenes. For example, the image exposure time of the detector/camera device, mechanism, or assembly, of the hyper-spectral image converting unit is, preferably, in a range of between about 0.1 millisecond and about 5 milliseconds, and the image conversion time of the spectral image converting unit is, preferably, in a range of between about 1 millisecond and about 10 milliseconds.

In the above described generalized hyper-spectral imaging and analysis system, device, or/and apparatus, the data-information processing and analyzing unit is for programming, processing, analyzing, and storing the various data and information, or/and signals thereof, of the units and components thereof, of the hyper-spectral imaging and analysis system, device, or/and apparatus. Accordingly, the various data and information, or/and signals thereof, of the units and components thereof, of the hyper-spectral imaging and analysis system, device, or/and apparatus, are programmed, processed, analyzed, and stored, by the data-information processing and analyzing unit.

In particular, data and information, or/and signals thereof, of the illuminating unit, of the hyper-spectral imaging unit, and of the hyper-spectral image converting unit, and optionally, of the optional synchronizing unit, and optionally, of the optional operator workstation unit, of the hyper-spectral imaging and analysis system, device, or/and apparatus, which are sent and received via appropriate data and information input/output (I/O) signal paths and junctions, are programmed, processed, analyzed, and stored by the data-information processing and analyzing unit.

More specifically, the data-information processing and analyzing unit is for programming, processing, analyzing, and storing, the various data and information, or/and signals thereof, associated with: (1) incident electromagnetic radiation generated and optically supplied by the illuminating unit to the objects of (included or contained in) the imaged scenes; (2) affected energies or emission beams emitted by, and emerging from, the illuminated objects, which are optically detected and processed by the hyper-spectral imaging unit, for generating optical forms of hyper-spectral images of the illuminated objects of the imaged scenes; and (3) optical forms of the hyper-spectral images of the illuminated objects, which are generated by the hyper-spectral imaging unit, and are converted to corresponding electronic forms of the hyper-spectral images, by the hyper-spectral image converting unit.

The data-information processing and analyzing unit is also for programming, processing, analyzing, and storing data and information, or/and signals thereof, associated with optional, and preferable, synchronization of overall operation and operating parameters of the units and components thereof, of the hyper-spectral imaging and analysis system, singly, in combination with each other, and, optionally, in combination with peripheral, auxiliary, or/and external, equipment (hardware or/and software) and, operation and operating parameters thereof, by the optional synchronizing unit.

The data-information processing and analyzing unit includes all the necessary software, including operatively connected and functioning written or printed data, in the form of software programs, software routines, software sub-routines, software symbolic languages, software code, software instructions or protocols, software algorithms, or/and a combination thereof, and includes all the necessary hardware, for programming, processing, analyzing, and storing data and information, or/and signals thereof, which are associated with performing the above described functions and operations of the hyper-spectral imaging and analysis system, and which are associated with implementing and practicing the herein illustratively described embodiments of the method of analyzing and classifying objects via hyper-spectral imaging and analysis.

In particular, the data-information processing and analyzing unit includes all the necessary software for performing the steps or procedures of embodiments of the method of the present invention, during real time (in-line or on-line) or/and during non-real time (off-line), for optimally and highly efficiently, integrating the two main activities of processing, and analyzing, hyper-spectral image data and information, namely, (i) automatic (i.e., computerized) data and information manipulating, handling, or/and moving, types of procedures or/and operations, and, (ii) automatic (i.e., computerized) data and information analyzing, identifying (recognizing), discriminating, comparing, filtering, sorting, quantifying, characterizing, and classifying, types of procedures or/and operations.

Additionally, embodiments of the method of the present invention are implementable or operable for being generally applicable to, and integratable with, various different types or kinds of physical hardware equipment and instrumentation, and, (computer) software, which comprise a given hyper-spectral imaging system, device, or apparatus, which is operable during real time or/and during non-real time.

For implementing embodiments of the method of the present invention, main or principal procedures, steps, and sub-steps, are performed by including the use of the same or/and specially modified methodologies of automatic pattern recognition (APR) and classification types of spectral or hyper-spectral image data and information processing and analyzing which are described in same applicant/assignee prior disclosures [e.g., 20-27], and described in references cited therein. This is especially the case where, for example, a particular biological, physical, or/and chemical, object (entity, material, substance, or structure) of (included or contained in) an imaged scene either is, or contains, particulate matter or particulate-like matter (i.e., matter having particle-like features, characteristics, properties, and behavior).

For performing the automatic pattern recognition (APR) and classification types of hyper-spectral image data and information processing and analyzing, there is applying one or more image analysis algorithms, such as detection, pattern recognition and classification, and/or decision image analysis algorithms, to the hyper-spectral image data and information. The imaged scenes include or contain hyper-spectral image data and information relating to the imaged object(s), particularly in the form of spectral representations, such as spectral fingerprint or signature pattern types of identification and characterization, of the imaged object(s).

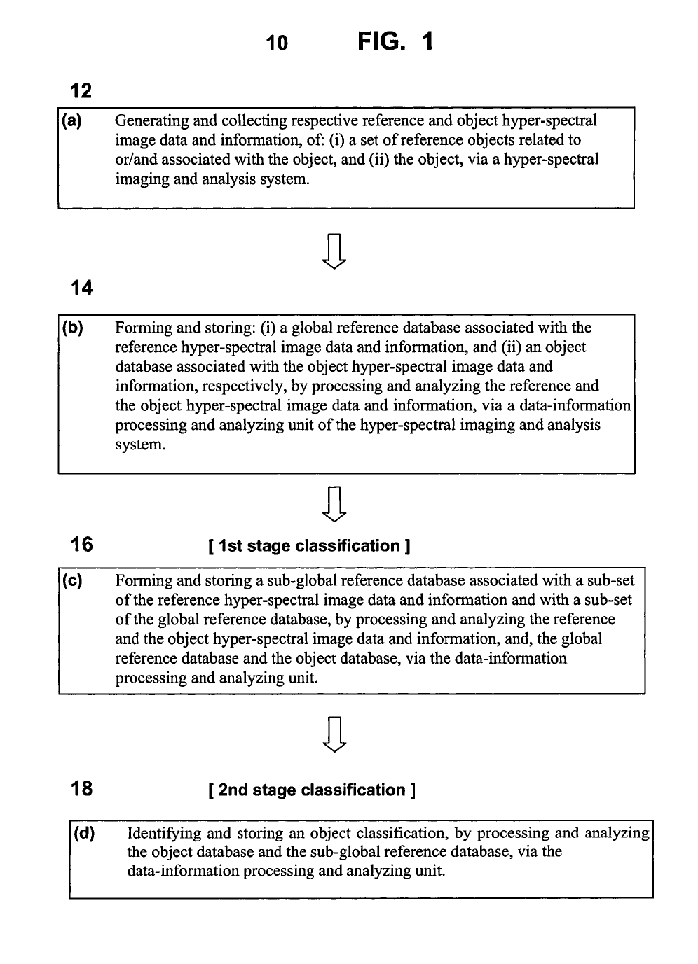

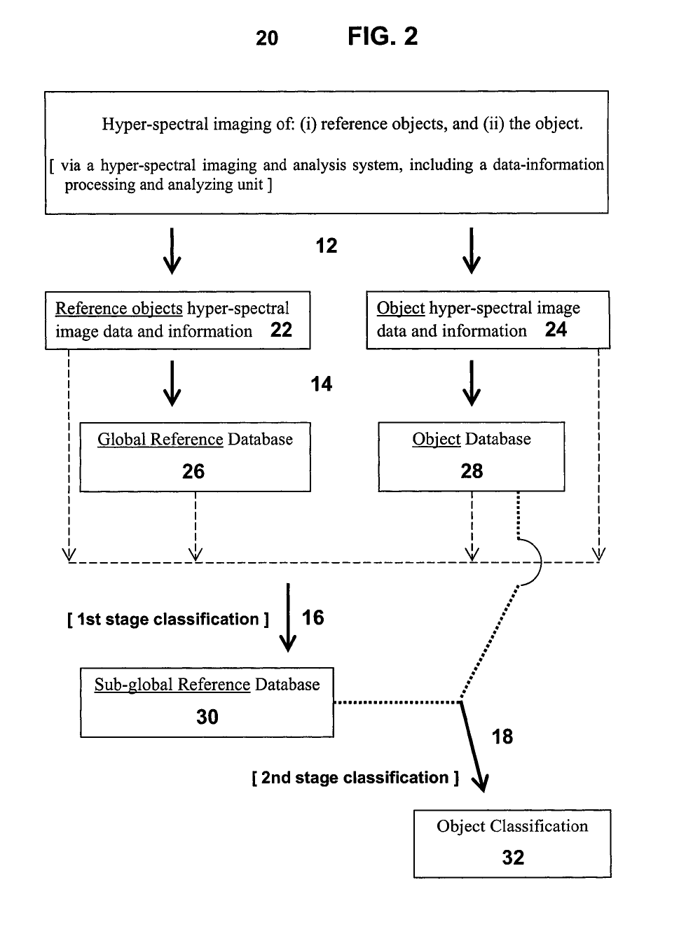

Referring now to the drawings, FIG. 1 is a (block-type) flow diagram of an exemplary embodiment of the main steps or procedures of the method (herein, generally referred to by reference number 10) of analyzing and classifying objects via hyper-spectral imaging and analysis, in accordance with the present invention. In FIG. 1, each main step (procedure) of the embodiment shown is enclosed inside a separate block (frame) which is assigned a reference number. Accordingly, main steps (a), (b), (c), and (d), are enclosed inside of blocks (frames) 12, 14, 16, and 18, respectively. FIG. 2 is a schematic flow diagram (herein, generally referred to by reference number 20) including main steps, and selected main aspects and features thereof, of the method 10 of analyzing and classifying objects via hyper-spectral imaging and analysis shown in FIG. 1, in accordance with the present invention. Phraseology, terminology, and, notation, appearing in the following illustrative description are consistent with those appearing in FIGS. 1 and 2.

With reference to FIGS. 1 and 2, an exemplary embodiment of the method 10 of analyzing and classifying an object via hyper-spectral imaging and analysis includes the following main steps or procedures, and, components and functionalities thereof.

In Step (a) [12 in FIGS. 1 and 2], there is generating and collecting respective reference objects hyper-spectral image data and information [22, FIG. 2] and (actual, under investigation) object hyper-spectral image data and information [24, FIG. 2], of: (i) a set of reference objects related to or/and associated with the (actual, under investigation) object, and (ii) the (actual, under investigation) object, respectively, via a hyper-spectral imaging and analysis system.

In Step (b), [14 in FIGS. 1 and 2], there is forming and storing: (i) a global reference database [26, FIG. 2] associated with the reference objects hyper-spectral image data and information [22, FIG. 2], and (ii) an object database [28, FIG. 2] associated with the object hyper-spectral image data and information [24, FIG. 2], respectively, by processing and analyzing the reference objects and the object hyper-spectral image data and information [22, 24, respectively, FIG. 2], via a data-information processing and analyzing unit of the hyper-spectral imaging and analysis system.

In Step (c), [16 in FIGS. 1 and 2; also indicated in FIG. 2 by the dashed arrows and line], there is forming and storing a sub-global reference database [30, FIG. 2] associated with a sub-set of the reference objects hyper-spectral image data and information [22, FIG. 2] and with a sub-set of the global reference database [26, FIG. 2], by processing and analyzing the reference objects and the object hyper-spectral image data and information [22, 24, respectively, FIG. 2], and, the global reference database and the object database [26, 28, respectively, FIG. 2], via the data-information processing and analyzing unit. As indicated in FIGS. 1 and 2, Step (c) corresponds to a ‘first (1st) stage classification’ procedure, since, for forming the sub-global reference database [30, FIG. 2], there is an initial or ‘first stage’ of the overall object analysis and classification method, based on analyzing and classifying elements, and using the element classifications, which are included in the reference objects and the object hyper-spectral image data and information [22, 24, respectively, FIG. 2], along with analyzing and classifying elements, and using the element classifications, which make up the global reference database and the object database [26, 28, respectively, FIG. 2].

In Step (d), [18 in FIGS. 1 and 2; also indicated in FIG. 2 by the dotted lines], there is identifying and storing an object classification [32, FIG. 2], by processing and analyzing the object database and the sub-global reference database [28, 30, respectively, FIG. 2], via the data-information processing and analyzing unit. As indicated in FIGS. 1 and 2, Step (d) corresponds to a ‘second (2nd) stage classification’ procedure, since, for identifying and storing an object classification [32, FIG. 2], there is a ‘second stage’ of the overall object analysis and classification method, based on analyzing and classifying elements, and using the element classifications, which make up the object database and the sub-global reference database [28, 30, respectively, FIG. 2].

Details of performing and implementing each of the above stated main steps (procedures) of an exemplary embodiment of the method of analyzing and classifying an object via hyper-spectral imaging and analysis, are provided as follows, with reference to FIGS. 1 and 2.

Generating and Collecting Respective Reference Objects and Object Hyper-Spectral Image Data and Information, of (i) a Set of Reference Objects Related to or/and Associated with the Object, and (ii) the Object, Via a Hyper-Spectral Imaging and Analysis System

In Step (a) [12 in FIGS. 1 and 2], of an exemplary embodiment of the method of analyzing and classifying an object via hyper-spectral imaging and analysis, there is generating and collecting respective reference objects hyper-spectral image data and information [22, FIG. 2] and object hyper-spectral image data and information [24, FIG. 2], of: (i) a set of reference objects related to or/and associated with the object, and (ii) the object, respectively, via a hyper-spectral imaging and analysis system.

This main step (procedure) is performed according to any suitable teaching or practice of generating and collecting hyper-spectral image data and information, of a set of reference objects, and of the object, using any suitable hyper-spectral imaging and analysis system and technique. For example, for performing this main step (procedure), there is using any suitable teaching or practice disclosed in references 1-19 (and references cited therein). Preferably, there is using the selected teachings and practices of hyper-spectral imaging and analysis by the same applicant/assignee of the present invention which are disclosed in references 20-27. Main aspects of such teachings and practices of hyper-spectral imaging and analysis, which are directly applicable to implementing this main step of an exemplary embodiment of the method of the present invention, are described in the hereinabove Background section.

This main step (procedure) is also performed by using any of the various possible different or optional embodiments of the ‘generalized’ hyper-spectral imaging and analysis system, device, or/and apparatus, and main components thereof, as described hereinabove Description section.

For example, each reference object or at least a part thereof, and the object or at least a part thereof, is appropriately (statically or dynamically) positioned relative to the illuminating unit, or/and to the hyper-spectral imaging unit. Such (static or dynamic) relative positioning is performed by using, for example, one or more three-dimensionally movable (i.e., translational), and optionally, angularly movable (i.e., rotational), examination stages or platforms of the hyper-spectral imaging and analysis system. The (static or dynamic) relative positioning is performed for either ‘statically’ or ‘dynamically’ hyper-spectrally imaging each given object. In general, at a given instant of time, each given reference object or object is in a ‘static’ (fixed or immobile) state, or, in a ‘dynamic’ (moving or mobile) state, with respect to a fixed reference point defined by a set of fixed reference position and angular coordinates (e.g., x, y, and z, position coordinates, and θ angular coordinate), which are either internal or external to a scene of the given object. Alternatively, at a given instant of time, the illuminating unit, or/and the hyper-spectral imaging unit, is/are in a ‘static’ (fixed or immobile) state, or, in a ‘dynamic’ (moving or mobile) state, with respect to a fixed reference point defined by a set of fixed reference position and angular coordinates (e.g., x, y, and z, position coordinates, and θ angular coordinate), which are either internal or external to a scene of the given reference object or object.

Accordingly, each reference object or at least a part thereof, and the object or at least a part thereof, is subjected to subjected to hyper-spectral imaging and analysis. Multiple fields of view of each given object are hyper-spectrally scanned and imaged while being exposed to electromagnetic radiation. During the hyper-spectral scanning and imaging there is generating and collecting relatively large numbers (up to the order of millions) of multiple spectral (i.e., hyper-spectral) images, ‘one-at-a-time’, but, in an extremely fast or rapid sequential manner, of each given object (and components thereof) emitting electromagnetic radiation at a plurality of many wavelengths (or frequencies, energy) where the wavelengths (frequencies, energies) are associated with different selected (relatively narrow) portions or bands, or bands therein, of an entire hyper-spectrum emitted by the object (and components thereof). The hyper-spectral imaging and analysis system can be operated in an extremely fast or rapid manner for providing exceptionally highly resolved spectral and spatial data and information of the imaged object (and components thereof).

Exemplary reference objects hyper-spectral image data and information [22, FIG. 2] and exemplary object hyper-spectral image data and information [24, FIG. 2], include the various operating conditions and parameters of, and results obtained from, the hyper-spectral imaging and analysis system, device, or/and apparatus, and main components thereof.

Exemplary reference objects hyper-spectral image data and information [22, FIG. 2] and exemplary object hyper-spectral image data and information [24, FIG. 2], include data and information regarding the various operating conditions and parameters (such as illuminating wavelengths (or frequencies, energies [intensities]) and bands thereof, exposure time durations, fields of views), among others), of, and results obtained from: (i) the illuminating unit, for generating and optically supplying electromagnetic radiation to the reference objects, and to the objects, among a plurality, collection, or ensemble, of several reference objects or objects (i.e., entities, materials, substances, or structures) of (included or contained in) the surroundings or place of each scene which is imaged in a plurality of hyper-spectral images, via one or more fields of view, for forming illuminated reference objects, and an illuminated object.

Exemplary reference objects hyper-spectral image data and information [22, FIG. 2] and exemplary object hyper-spectral image data and information [24, FIG. 2], also include data and information regarding the various operating conditions and parameters (such as reference object or object emission wavelengths (or frequencies, energies [intensities])) of, and results obtained from: (ii) the hyper-spectral imaging unit, for optically detecting the affected energies or emission beams (and bands thereof) emitted by, and emerging from, the illuminated reference objects, and the illuminated object, and for generating optical forms of hyper-spectral images of the illuminated reference objects, and of the illuminated object, of the imaged scenes.

Exemplary reference objects hyper-spectral image data and information [22, FIG. 2] and exemplary object hyper-spectral image data and information [24, FIG. 2], also include data and information regarding the various operating conditions and parameters (such as reference object or object image shapes (profiles, forms), and image qualities [resolutions, brightnesses, darknesses]) of, and results obtained from: (iii) the hyper-spectral image converting unit, for converting the optical forms of the hyper-spectral images to corresponding electronic forms of the hyper-spectral images of the reference objects, and of the object.

Exemplary reference objects hyper-spectral image data and information [22, FIG. 2] and exemplary object hyper-spectral image data and information [24, FIG. 2], also include data and information regarding the various operating conditions and parameters of, and results obtained from: (iv) the data-information processing and analyzing unit, for programming, processing, analyzing, and storing the various data and information, or/and signals thereof, of the units and components thereof, of the hyper-spectral imaging and analysis system, device, or/and apparatus.

All of the above exemplary reference objects hyper-spectral image data and information [22, FIG. 2], and exemplary object hyper-spectral image data and information [24, FIG. 2], are generated and collected for: (i) the set of reference objects related to or/and associated with the object, and (ii) the object, respectively, via the hyper-spectral imaging and analysis system.

Forming and Storing: (i) a Global Reference Database Associated with the Reference Objects Hyper-Spectral Image Data and Information, and (ii) an Object Database Associated with the Object Hyper-Spectral Image Data and Information, Respectively, by Processing and Analyzing the Reference Objects and the Object Hyper-Spectral Image Data and Information, Via a Data-Information Processing and Analyzing Unit of the Hyper-Spectral Imaging and Analysis System

In Step (b), [14 in FIGS. 1 and 2], there is forming and storing: (i) a global reference database [26, FIG. 2] associated with the reference objects hyper-spectral image data and information [22, FIG. 2], and (ii) an object database [28, FIG. 2] associated with the object hyper-spectral image data and information [24, FIG. 2], respectively, by processing and analyzing the reference objects and the object hyper-spectral image data and information [22, 24, respectively, FIG. 2], via a data-information processing and analyzing unit of the hyper-spectral imaging and analysis system.

This main step (procedure) is also performed according to any suitable teaching or practice of forming and storing databases of hyper-spectral image data and information, associated with sets of objects (i.e., a set of reference objects, and a set of the [actual, investigated] object), using any suitable hyper-spectral imaging and analysis system and technique. Preferably, there is using the selected teachings and practices of hyper-spectral imaging and analysis by the same applicant/assignee of the present invention which are disclosed in references 20-27. Main aspects of such teachings and practices of hyper-spectral imaging and analysis, which are directly applicable to implementing this main step of an exemplary embodiment of the method of the present invention, are described in the hereinabove Background section.

This main step (procedure) is also performed by using the hyper-spectral imaging and analysis techniques described hereinabove in the Description section. This main step also includes processing and analyzing emission spectra of the reference objects (and components thereof), and of the objects (and components thereof), where the emission spectra correspond to spectral representations in the form of spectral fingerprints (SFP) or signature pattern types of identification and characterization, of the hyper-spectrally imaged reference objects (and components thereof), and of the hyper-spectrally imaged objects (and components thereof), respectively

The reference objects hyper-spectral image data and information [22, FIG. 2] are processed and analyzed for forming and storing a global reference database [26, FIG. 2], and the object hyper-spectral image data and information [24, FIG. 2] are processed and analyzed for forming and storing an object database [28, FIG. 2].

All of the above exemplary reference objects hyper-spectral image data and information [22, FIG. 2], and exemplary object hyper-spectral image data and information [24, FIG. 2], which are generated and collected for: (i) the set of reference objects related to or/and associated with the object, and (ii) the object, via the hyper-spectral imaging and analysis system, according to main Step (a), are processed and analyzed for forming the global reference database [26, FIG. 2], and for forming the object database [28, FIG. 2].

Hyper-spectral images generated by, and collected from, the reference objects are correlated with emission spectra of the reference objects (and components thereof), where the emission spectra correspond to spectral representations in the form of spectral ‘fingerprint’ or ‘signature’ pattern types of identification and characterization, of the hyper-spectrally imaged reference objects (and components thereof). Similarly, hyper-spectral images generated by, and collected from, the object are correlated with emission spectra of the objects (and components thereof), where the emission spectra correspond to spectral representations in the form of spectral ‘fingerprint’ or ‘signature’ pattern types of identification and characterization, of the hyper-spectrally imaged object (and components thereof). Such ‘hyper-spectral image’ correlation data and information of the reference objects are used for forming, and are considered as elements of, the global reference database [26, FIG. 2], and such ‘hyper-spectral image’ correlation data and information of the object are used for forming, and are considered as elements of, the object database [28, FIG. 2].

Real time or/and non-real time processing and analyzing of the hyper-spectral image data and information are performed for the main goal of relating and translating the hyper-spectral image data and information of the imaged reference objects and of the imaged objects (and components thereof) to micro scale or/and macro scale (qualitative or/and quantitative) biological, physical, or/and chemical, (biophysicochemical) properties, characteristics, and behavior, of the imaged reference objects and of the imaged object, (and components thereof), respectively.

Accordingly, this main step includes obtaining micro scale or/and macro scale (qualitative or/and quantitative) biological, physical, or/and chemical, (biophysicochemical) properties, characteristics, and behavior, for each of: (i) the set of reference objects related to or/and associated with the object, and (ii) the object. Then, there is correlating the biophysicochemical properties, characteristics, and behavior, of the reference objects with the reference objects hyper-spectral image data and information [22, FIG. 2]. Such ‘biophysicochemical’ correlation data and information of the reference objects are also used for forming, and are also considered as elements of, the global reference database [26, FIG. 2]. Similarly, there is correlating the biophysicochemical properties, characteristics, and behavior, of the object with the object hyper-spectral image data and information [24, FIG. 2]. Such ‘biophysicochemical’ correlation data and information of the object are also used for forming, and are also considered as elements of, the object database [28, FIG. 2]. The global reference database [26, FIG. 2] (including elements of ‘hyper-spectral image’ correlation data and information, and, elements of ‘biophysicochemical’ correlation data and information, of reference objects), and the object database [28, FIG. 2] (including elements of ‘hyper-spectral image’ correlation data and information, and, elements of ‘biophysicochemical’ correlation data and information, of the object), are then stored in the data-information processing and analyzing unit of the hyper-spectral imaging and analysis system.

Forming and Storing a Sub-Global Reference Database Associated with a Sub-Set of the Reference Hyper-Spectral Image Data and Information and with a Sub-Set of the Global Reference Database, by Processing and Analyzing the Reference and the Object Hyper-Spectral Image Data and Information, and, the Global Reference Database and the Object Database, Via the Data-Information Processing and Analyzing Unit

In Step (c), [16 in FIGS. 1 and 2; also indicated in FIG. 2 by the dashed arrows and line], there is forming and storing a sub-global reference database [30, FIG. 2] associated with a sub-set of the reference objects hyper-spectral image data and information [22, FIG. 2] and with a sub-set of the global reference database [26, FIG. 2], by processing and analyzing the reference objects and the object hyper-spectral image data and information [22, 24, respectively, FIG. 2], and, the global reference database and the object database [26, 28, respectively, FIG. 2], via the data-information processing and analyzing unit.

As indicated in FIGS. 1 and 2, Step (c) corresponds to a ‘first (1st) stage classification’ procedure, since, for forming the sub-global reference database [30, FIG. 2], there is an initial or ‘first stage’ of the overall object analysis and classification method, based on analyzing and classifying elements, and using the element classifications, which are included in the reference objects and the object hyper-spectral image data and information [22, 24, respectively, FIG. 2], along with analyzing and classifying elements, and using the element classifications, which make up the global reference database and the object database [26, 28, respectively, FIG. 2].

For performing this main step, there is forming, and storing, sets of reference object feature functions, [FF(ref. object)ᵢ, for i=1 to M], and object feature functions, [FF(object)ⱼ, for j=1 to N]. For each hyper-spectrally imaged reference object, there is defining and forming any number of reference object feature functions. Similarly, for each hyper-spectrally imaged object, there is defining and forming any number of object feature functions.

For a given reference object, each reference object feature function, FF(ref. object)ᵢ, is defined in terms of, related to, or/and associated with, elements of the global reference database [26, FIG. 2], namely, elements of ‘hyper-spectral image’ correlation data and information, and, elements of ‘biophysicochemical’ correlation data and information, of reference objects.

For a given reference object, each reference object feature function, FF(ref. object)ᵢ, is a (linear or non-linear) function of one or more hyper-spectral imaging parameters, such as reference object: emission wavelengths (or/and frequencies, or/and energies [intensities]); image shapes (profiles, forms); and image qualities [resolutions, brightnesses, darknesses], of the hyper-spectrally imaged reference object. Each reference object feature function, FF(ref. object)ᵢ, is related to or/and associated with one or more particular biophysicochemical properties, characteristics, or behaviors, of the reference object.

Similarly, for the object, each object feature function, FF(object)ⱼ, is defined in terms of, related to, or/and associated with, elements of the object database [28, FIG. 2], namely, elements of ‘hyper-spectral image’ correlation data and information, and, elements of ‘biophysicochemical’ correlation data and information, of the object.

Similarly, for the object, each object feature function, FF(object)ⱼ, is a (linear or non-linear) function of one or more hyper-spectral imaging parameters, such as object: emission wavelengths (or/and frequencies, or/and energies [intensities]); image shapes (profiles, forms); and image qualities [resolutions, brightnesses, darknesses], of the hyper-spectrally imaged object. Each object feature function, FF(object)ⱼ, is related to or/and associated with one or more particular biophysicochemical properties, characteristics, or behaviors, of the object.

Exemplary forms of a reference object feature function, FF(ref. object)ᵢ, and of an object feature function, FF(object)j, are linear or/and non-linear combinations (e.g., sums, differences, products, or/and ratios) of one or more hyper-spectral imaging parameters (such as reference object or object: emission wavelengths (or/and frequencies, or/and energies [intensities]); image shapes (profiles, forms); and image qualities [resolutions, brightnesses, darknesses]) of the hyper-spectrally imaged reference object or of the hyper-spectrally imaged object, respectively. Additional exemplary forms of a reference object feature function, FF(ref. object)ᵢ, and of an object feature function, FF(object)ⱼ, are functions (such as absolute value, maximum value, minimum value, or/and logarithmic value) of the linear or/and non-linear combinations (e.g., sums, differences, products, or/and ratios) of one or more hyper-spectral imaging parameters (such as object emission wavelengths (or/and frequencies, or/and energies [intensities]); image shapes (profiles, forms); and image qualities [resolutions, brightnesses, darknesses]) of the hyper-spectrally imaged reference object or of the hyper-spectrally imaged object, respectively.

A first specific exemplary form of a reference object feature function, FF(ref. object)ᵢ, and of an object feature function, FF(object)ⱼ, which was found to be particularly useful for implementing exemplary embodiments of the two-stage classification procedure, is the ratio of two different reference object, or object, emission wavelengths (or frequencies, or energies [intensities]), of a hyper-spectrally imaged reference object, or object, respectively, which are identified and selected from two corresponding different specific locations in a hyper-spectral image of the reference object, or object, respectively. Moreover, wherein each such exemplary (ratio) form of the reference object feature function, FF(ref. object)ᵢ, and of the object feature function, FF(object)ⱼ, are related to or/and associated with either one particular biophysicochemical property, characteristic, or behavior, of the reference object or of the object, respectively, or, alternatively, are related to or/and associated with two different particular biophysicochemical properties, characteristics, or behaviors, of the reference object or of the object, respectively.

A second specific exemplary form of a reference object feature function, FF(ref. object)ᵢ, and of an object feature function, FF(object)ⱼ, which was found to be particularly useful for implementing exemplary embodiments of the two-stage classification procedure, is the ratio of two different reference object, or object, image shapes (profiles, forms), of a hyper-spectrally imaged reference object, or object, respectively, which are identified and selected from two corresponding different specific locations in a hyper-spectral image of the reference object, or object, respectively. Moreover, wherein each such exemplary (ratio) form of the reference object feature function, FF(ref. object)ᵢ, and of the object feature function, FF(object)ⱼ, are related to or/and associated with either one particular biophysicochemical property, characteristic, or behavior, of the reference object or of the object, respectively, or, alternatively, are related to or/and associated with two different particular biophysicochemical properties, characteristics, or behaviors, of the reference object or of the object, respectively.

A third specific exemplary form of a reference object feature function, FF(ref. object)ᵢ, and of an object feature function, FF(object)ⱼ, which was found to be particularly useful for implementing exemplary embodiments of the two-stage classification procedure, is the ratio of two different reference object, or object, image qualities [resolutions, brightnesses, darknesses], of a hyper-spectrally imaged reference object, or object, respectively, which are identified and selected from two corresponding different specific locations in a hyper-spectral image of the reference object, or object, respectively. Moreover, wherein each such exemplary (ratio) form of the reference object feature function, FF(ref. object)ᵢ, and of the object feature function, FF(object)ⱼ, are related to or/and associated with either one particular biophysicochemical property, characteristic, or behavior, of the reference object or of the object, respectively, or, alternatively, are related to or/and associated with two different particular biophysicochemical properties, characteristics, or behaviors, of the reference object or of the object, respectively.

Accordingly, this main step includes defining and forming any number and type of reference object feature functions, FF(ref. object)ᵢ, for i=1 to M, being (linear or non-linear) functions of one or more hyper-spectral imaging parameters (such as reference object: emission wavelengths (frequencies, energies [intensities]); image shapes (profiles, forms); and image qualities [resolutions, brightnesses, darknesses]), of each of the hyper-spectrally imaged reference objects, where each reference object feature function, FF(ref. object)ᵢ, is related to or/and associated with one or more particular biophysicochemical properties, characteristics, or behaviors, of a given reference object.

Similarly, this main step also includes defining and forming any number and type of object feature functions, FF(object)ⱼ, for j=1 to N, being (linear or non-linear) functions of one or more hyper-spectral imaging parameters (such as object: emission wavelengths (frequencies, energies [intensities]); image shapes (profiles, forms); and image qualities [resolutions, brightnesses, darknesses]), of the hyper-spectrally imaged object, where each object feature function, FF(object)j, is related to or/and associated with one or more particular biophysicochemical properties, characteristics, or behaviors, of the object.

This ‘first stage classification’ procedure, for forming the sub-global reference database [30, FIG. 2], is based on analyzing and classifying elements, and using the element classifications, which are included in the reference objects and the object hyper-spectral image data and information [22, 24, respectively, FIG. 2], along with analyzing and classifying elements, and using the element classifications, which make up the global reference database and the object database [26, 28, respectively, FIG. 2].

This main step is also performed by evaluating, and analyzing the preceding described reference object feature functions, FF(ref. object)ᵢ, and the object feature functions, FF(object)ⱼ, for forming the sub-global reference database [30, FIG. 2], via the data-information processing and analyzing unit of the hyper-spectral imaging and analysis system.

The sub-global reference database [30, FIG. 2] is then stored in the data-information processing and analyzing unit of the hyper-spectral imaging and analysis system.

### Identifying and Storing an Object Classification, by Processing and Analyzing the Object Database and the Sub-Global Reference Database, Via the Data-Information Processing and Analyzing Unit

In Step (d), [18 in FIGS. 1 and 2; also indicated in FIG. 2 by the dotted lines], there is identifying and storing an object classification [32, FIG. 2], by processing and analyzing the object database and the sub-global reference database [28, 30, respectively, FIG. 2], via the data-information processing and analyzing unit.

As indicated in FIGS. 1 and 2, Step (d) corresponds to a ‘second (2nd) stage classification’ procedure, since, for identifying and storing an object classification [32, FIG. 2], there is a ‘second stage’ of the overall object analysis and classification method, based on analyzing and classifying elements, and using the element classifications, which make up the object database and the sub-global reference database [28, 30, respectively, FIG. 2].

For performing this main step, there is processing and analyzing values of the sets of reference object feature functions, associated with the sub-global reference database [30, FIG. 2], and of object feature functions, associated with the object database [28, FIG. 2], as evaluated in preceding main Step (c). Then, there is comparing such values, for identifying values of the object feature functions which, identically or approximately, equal (match), or correspond to, values of the reference object feature functions, and assigning such values to the object classification. The object classification assigned values are then stored in the data-information processing and analyzing unit of the hyper-spectral imaging and analysis system.

Optionally, the hereinabove illustratively described main Steps (b) and (c) of the exemplary embodiment of the method of analyzing and classifying an object via hyper-spectral imaging and analysis, of the present invention, are subjected to dynamic database updating, particularly, as disclosed in the same applicant/assignee reference 21.

It is to be fully understood that certain aspects, characteristics, and features, of the present invention, which are illustratively described and presented in the context or format of a plurality of separate embodiments, may also be illustratively described and presented in any suitable combination or sub-combination in the context or format of a single embodiment. Conversely, various aspects, characteristics, and features, of the present invention, which are illustratively described and presented in combination or sub-combination in the context or format of a single embodiment, may also be illustratively described and presented in the context or format of a plurality of separate embodiments.

Although the present invention has been illustratively described and presented by way of specific embodiments, and examples thereof, it is evident that many alternatives, modifications, and variations, thereof, will be apparent to those skilled in the art. Accordingly, it is intended that all such alternatives, modifications, and variations, fall within, and are encompassed by, the scope of the appended claims.

All patents, patent applications, and publications, cited or referred to in this specification are herein incorporated in their entirety by reference into the specification, to the same extent as if each individual patent, patent application, or publication, was specifically and individually indicated to be incorporated herein by reference. In addition, citation or identification of any reference in this specification shall not be construed or understood as an admission that such reference represents or corresponds to prior art of the present invention. To the extent that section headings are used, they should not be construed as necessarily limiting.

### REFERENCES

1. U.S. Pat. No. 6,995,840, to Hagler, entitled: “Method And Apparatus For Radiation Encoding And Analysis”.
2. U.S. Pat. No. 6,992,809, to Wang, et al., entitled: “Multi-conjugate Liquid Crystal Tunable Filter”.
3 (a,b,c). U.S. Pat. Nos. 6,922,645 (a), 6,842,702 (b), and 6,687,620 (c), each to Haaland, et al., each entitled: “Augmented Classical Least Squares Multivariate Spectral Analysis”.
4. U.S. Pat. No. 6,912,322, to Smith, et al., entitled: “Adaptive Process For Removing Streaks In Multi-band Digital Images”.
5. U.S. Pat. No. 6,886,953, to Cook, entitled: “High-resolution, All-reflective Spectrometer”.
6. U.S. Pat. No. 6,724,940, to Qian, et al., entitled: “System And Method For Encoding Multidimensional Data Using Hierarchical Self-organizing Cluster Vector Quantization”.
7 (a,b). U.S. Pat. Nos. 6,711,503 (a), and 6,341,257 (b), each to Haaland, each entitled: “Hybrid Least Squares Multivariate Spectral Analysis Methods”.
8. U.S. Pat. No. 6,701,021, to Qian, et al., entitled: “System And Method For Encoding/Decoding Multidimensional Data Using Successive Approximation Multi-stage Vector Quantization”.
9. U.S. Pat. No. 6,546,146, to Hollinger, et al., entitled: “System For Interactive Visualization And Analysis Of Imaging Spectrometry Datasets Over A Wide-area Network”.
10. U.S. Pat. No. 6,415,233, to Haaland, entitled: “Classical Least Squares Multivariate Spectral Analysis”.
11. U.S. Pat. No. 6,018,587, to Cabib, entitled: “Method For Remote Sensing Analysis By Decorrelation Statistical Analysis And Hardware Therefor”.
12. U.S. Pat. No. 5,782,770, to Mooradian, et al., entitled: “Hyperspectral Imaging Methods And Apparatus For Non-invasive Diagnosis Of Tissue For Cancer”.
13. U.S. Pat. No. 5,724,135, to Bernhardt, entitled: “Hyper-spectral Imaging Using Rotational Spectro-tomography”.
14. Fluorescence Imaging Spectroscopy and Microscopy, edited by Wang, X. F., and Herman, B., Vol. 137 of Chemical Analysis, edited by Winefordner, J. D., published by John Wiley & Sons, Inc., New York (1996).
15. Computer-Assisted Microscopy—The Measurement and Analysis of Images, by Russ, J. C., published by Plenum Press, New York, Plenum Publishing Corp., New York, USA (1990).
16. Fourier Transforms in Spectroscopy, by Kauppinen, J., and Partanen, J., 1st edition, published by Wiley-VCH Verlag Berlin GmbH, Berlin, Germany (2001).
17. Fundamentals of Fourier Transform Infrared Spectroscopy, by Smith, B. C., published by CRC Press LLC, Florida, USA (1996).
18. Kettig, R. L. and Landgrebe, D., “Classification Of Multispectral Image Data By Extraction And Classification Of Homogeneous Objects”, IEEE Transactions on Geoscience Electronics, Vol. GE14, 19 (1976).
19. Yu, P., Anastassopoulos, V., and Venetsanopoulos, A. N., “Pattern Classification And Recognition Based On Morphology And Neural Networks”, Can. J. Elect. and Comp. Eng., Vol. 17, No. 2, 58-59 (1992).
20. WIPO PCT Pat. Appl. Int'l. Pub. No. WO 2008/099407, published Aug. 21, 2008, of PCT Pat. Appl. No. IL2008/000205, filed Feb. 14, 2008, of same applicant/assignee as the present invention, entitled: “Hyper-spectral Imaging And Analysis Of A Sample Of Matter, And Preparing A Solution Or Suspension Therefrom”.
21. WIPO PCT Pat. Appl. Int'l. Pub. No. WO 2007/0990540, published Sep. 7, 2007, of PCT Pat. Appl. No. PCT/IL2007/000268, filed Mar. 1, 2007, of same applicant/assignee as the present invention, entitled: “Processing And Analyzing Hyper-spectral Image Data And Information Via Dynamic Database Updating”.
22. U.S. Pat. No. 7,411,682, to Moshe, of same applicant/assignee as the present invention, entitled: “Real Time High Speed High Resolution Hyper-spectral Imaging”.
23. U.S. Pat. No. 6,697,510, to Moshe, of same applicant/assignee as the present invention, entitled: “Method For Generating Intra-particle Crystallographic Parameter Maps And Histograms Of A Chemically Pure Crystalline Particulate Substance”.
24. U.S. Pat. No. 6,694,048, to Moshe, of same applicant/assignee as the present invention, entitled: “Method For Generating Intra-particle Morphological Concentration/Density Maps And Histograms Of A Chemically Pure Particulate Substance”.
25. U.S. Pat. No. 6,438,261, to Moshe, et al., of same applicant/assignee as the present invention, entitled: “Method Of In-situ Focus-fusion Multi-layer Spectral Imaging And Analysis”.
26. U.S. Pat. No. 6,091,843, to Horesh, et al., of same applicant/assignee as the present invention, entitled: “Method Of Clibration And Real-time Analysis Of Particulates”.
27. U.S. Pat. No. 5,880,830, to Schechter, of same applicant/assignee as the present invention, entitled: “Spectral Imaging Method For On-line Analysis Of Polycyclic Aromatic Hydrocarbons In Aerosols”.

What is claimed is:

1. A method of analyzing and classifying an object via hyper-spectral imaging and analysis, the method comprising:
generating and collecting respective reference objects and object hyper-spectral image data and information, of: (i) a set of reference objects related to or/and associated with the object, and (ii) the object, respectively, via a hyper-spectral imaging and analysis system;
forming and storing: (i) a global reference database associated with said reference objects hyper-spectral image data and information, and (ii) an object database associated with said object hyper-spectral image data and information, respectively, by processing and analyzing said reference objects and said object hyper-spectral image data and information, via a data-information processing and analyzing unit of said hyper-spectral imaging and analysis system;
forming and storing a sub-global reference database associated with a sub-set of said reference objects hyper-spectral image data and information and with a sub-set of said global reference database, by processing and analyzing said reference objects and said object hyper-spectral image data and information, and, said global reference database and said object database, via said data-information processing and analyzing unit; and
identifying and storing an object classification, by processing and analyzing said object database and said sub-global reference database, via said data-information processing and analyzing unit.

2. The method of claim 1, wherein said forming and storing said sub-global reference database includes forming, and storing sets of reference object feature functions and object feature functions.

3. The method of claim 2, wherein each said reference object feature function is defined in terms of, related to, or/and associated with, elements of said global reference database.

4. The method of claim 2, wherein each said object feature function is defined in terms of, related to, or/and associated with, elements of said object database.

5. The method of claim 2, wherein each said reference object feature function is a function of one or more hyper-spectral imaging parameters selected from the group consisting of reference object emission wavelengths, reference object emission frequencies, and reference object emission energies, of said hyper-spectrally imaged reference objects.

6. The method of claim 2, wherein each said reference object feature function is a function of one or more hyper-spectral imaging parameters selected from the group consisting of reference object image shapes, and reference object image qualities.

7. The method of claim 2, wherein each said reference object feature function is related to or/and associated with one or more particular biophysicochemical properties, characteristics, or behaviors, of said reference object.

8. The method of claim 5, wherein each said reference object feature function is related to or/and associated with one or more particular biophysicochemical properties, characteristics, or behaviors, of said reference object.

9. The method of claim 5, wherein said reference object feature function is a linear or/and non-linear combination of said hyper-spectral imaging parameters.

10. The method of claim 5, wherein said reference object feature function is a ratio of two of said hyper-spectral imaging parameters.

11. The method of claim 5, wherein said reference object feature function is a ratio of two different said hyper-spectral imaging parameters of a hyper-spectrally imaged reference object, which are identified and selected from two corresponding different specific locations in a hyper-spectral image of a said reference object.

12. The method of claim 10, wherein said ratio form of said reference object feature function is related to or/and associated with one biophysicochemical property, characteristic, or behavior, of said reference object.

13. The method of claim 10, wherein said ratio form of said reference object feature function is related to or/and associated with two different biophysicochemical properties, characteristics, or behaviors, of said reference object.

14. The method of claim 6, wherein each said reference object feature function is related to or/and associated with one or more particular biophysicochemical properties, characteristics, or behaviors, of said reference object.

15. The method of claim 6, wherein said reference object feature function is a linear or/and non-linear combination of said hyper-spectral imaging parameters.

16. The method of claim 6, wherein said reference object feature function is a ratio of two of said hyper-spectral imaging parameters.

17. The method of claim 6, wherein said reference object feature function is a ratio of two different said hyper-spectral imaging parameters of a hyper-spectrally imaged reference object, which are identified and selected from two corresponding different specific locations in a hyper-spectral image of a said reference object.

18. The method of claim 2, wherein each said object feature function is a function of one or more hyper-spectral imaging parameters selected from the group consisting of object emission wavelengths, object emission frequencies, and object emission energies, of said hyper-spectrally imaged object.

19. The method of claim 2, wherein each said object feature function is a function of one or more hyper-spectral imaging parameters selected from the group consisting of object image shapes, and object image qualities.

20. The method of claim 2, wherein each said object feature function is related to or/and associated with one or more particular biophysicochemical properties, characteristics, or behaviors, of the object.

21. The method of claim 18, wherein each said object feature function is related to or/and associated with one or more particular biophysicochemical properties, characteristics, or behaviors, of the object.

22. The method of claim 18, wherein said object feature function is a linear or/and non-linear combination of said hyper-spectral imaging parameters.

23. The method of claim 18, wherein said object feature function is a ratio of two of said hyper-spectral imaging parameters.

24. The method of claim 18, wherein said object feature function is a ratio of two different said hyper-spectral imaging parameters of a hyper-spectrally imaged object, which are identified and selected from two corresponding different specific locations in a hyper-spectral image of the object.

25. The method of claim 23, wherein said ratio form of said object feature function is related to or/and associated with one biophysicochemical property, characteristic, or behavior, of said reference object.

26. The method of claim 23, wherein said ratio form of said object feature function is related to or/and associated with two different biophysicochemical properties, characteristics, or behaviors, of said reference object.

27. The method of claim 19, wherein each said object feature function is related to or/and associated with one or more particular biophysicochemical properties, characteristics, or behaviors, of the object.

28. The method of claim 19, wherein said object feature function is a linear or/and non-linear combination of said hyper-spectral imaging parameters.

29. The method of claim 19, wherein said object feature function is a ratio of two of said hyper-spectral imaging parameters.

30. The method of claim 19, wherein said object feature function is a ratio of two different said hyper-spectral imaging parameters of the hyper-spectrally imaged object, which are identified and selected from two corresponding different specific locations in a hyper-spectral image of the object.

31. The method of claim 2, wherein said identifying and storing said object classification includes comparing values of said reference object feature functions to values of said object feature functions, for identifying said values which are identically or approximately equal, and assigning such said values to said object classification.
